(19) United States
(12) Patent Application Publication
(10) Pub. No.: US 2026/0054177 A1
(43) Pub. Date: Feb. 26, 2026

(54) METHOD AND APPARATUS FOR CONTROLLING VIRTUAL OBJECT, COMPUTER DEVICE, AND STORAGE MEDIUM

(71) Applicant: Tencent Technology (Shenzhen) Company Limited, Shenzhen (CN)

(72) Inventor: Xiaoquan HUANG, Shenzhen (CN)

(21) Appl. No.: 19/374,311

(22) Filed: Oct. 30, 2025

Related U.S. Application Data
(63) Continuation of application No. PCT/CN2024/089189, filed on Apr. 22, 2024.

(30) Foreign Application Priority Data
Jun. 21, 2023 (CN) 202310748937.6

(51) Int. Cl. A63F 13/56; A63F 13/5252; A63F 13/58

(52) U.S. Cl. CPC A63F 13/56; A63F 13/5252; A63F 13/58

(57) ABSTRACT

Provided are a method for controlling a virtual object performed by a computer device. The method includes: displaying a first virtual object's viewing-angle picture of a virtual scene controlled by the computer device; in response to an invasion operation by a slave virtual object of the first virtual object on a second virtual object in the virtual scene, switching the currently displayed viewing-angle picture to the second virtual object's viewing-angle picture of the virtual scene; and in response to a control operation on the second virtual object, causing the second virtual object to perform an action indicated by the control operation in the virtual scene. Accordingly, interaction methods in a virtual scene are enriched such that users can be attracted to interaction through an invasion, and interactivity between virtual objects is enhanced. Further, efficiency of human-computer interaction is improved, such that user experience is improved.

### CROSS-REFERENCE TO RELATED APPLICATIONS

This application is a continuation application of PCT Patent Application No. PCT/CN2024/089189, entitled “METHOD AND APPARATUS FOR CONTROLLING VIRTUAL OBJECT, COMPUTER DEVICE, AND STORAGE MEDIUM” filed on Apr. 22, 2024, which claims priority to Chinese Patent Application no. 202310748937.6, entitled “METHOD AND APPARATUS FOR CONTROLLING VIRTUAL OBJECT, COMPUTER DEVICE, AND STORAGE MEDIUM” filed on Jun. 21, 2023, both of which are incorporated in their entirety herein by reference.

### FIELD OF THE TECHNOLOGY

Embodiments of this application relate to the technical field of computers, and in particular, to a method and apparatus for controlling a virtual object, a computer device, and a storage medium.

### BACKGROUND OF THE DISCLOSURE

As computer technologies develop, games gain increasing favor of the majority of users. Each user controls a virtual object in a virtual battle. Specifically, the user controls the virtual object and an item owned by the virtual object to interact with other virtual objects. However, a current interaction method is single, leading to poor user experience.

### SUMMARY

Embodiments of this application provide a method and apparatus for controlling a virtual object, a computer device, and a storage medium, which can enrich interaction methods to improve user experience. Technical solutions are as follows:
in an aspect, a method for controlling a virtual object is performed by a computer device and the method includes:
displaying a first virtual object's viewing-angle picture of a virtual scene controlled by the computer device;
in response to an invasion operation by a slave virtual object of the first virtual object on a second virtual object in the virtual scene, switching the currently displayed viewing-angle picture to the second virtual object's viewing-angle picture of the virtual scene; and
in response to a control operation on the second virtual object, causing the second virtual object to perform an action indicated by the control operation in the virtual scene.

In another aspect, a computer device is provided. The computer device includes a processor and a memory, the memory having at least one computer program stored therein, the at least one computer program being loaded and executed by the processor and causing the computer device to implement operations performed by the method for controlling a virtual object as mentioned in the above aspects.

In yet another aspect, a non-transitory computer-readable storage medium is provided. The computer-readable storage medium has at least one computer program stored therein, the at least one computer program being loaded and executed by a processor of a computer device and causing the computer device to implement operations performed by the method for controlling a virtual object as mentioned in the above aspects.

In solutions provided in embodiments of this application, a slave virtual object of a virtual object has a function of invading another virtual object. By invading another virtual object by the slave virtual object, a terminal can control the invaded virtual object, and display a viewing-angle picture of the invaded virtual object. Thus, a user can observe a virtual scene from a viewing angle of the invaded virtual object, and control, according to the observed virtual scene, the invaded virtual object to interact with another virtual object in the virtual scene. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

### BRIEF DESCRIPTION OF THE DRAWINGS

FIG. 1 is a schematic structural diagram of an implementation environment according to an embodiment of this application;

FIG. 2 is a flowchart of a method for controlling a virtual object according to an embodiment of this application;

FIG. 3 is a flowchart of another method for controlling a virtual object according to an embodiment of this application;

FIG. 4 is a flowchart of yet another method for controlling a virtual object according to an embodiment of this application;

FIG. 5 is a flowchart of yet another method for controlling a virtual object according to an embodiment of this application;

FIG. 6 is a flowchart of yet another method for controlling a virtual object according to an embodiment of this application;

FIG. 7 is a schematic diagram of a viewing-angle picture of a first virtual object according to an embodiment of this application;

FIG. 8 is a schematic diagram of a viewing-angle picture of a virtual wasp according to an embodiment of this application;

FIG. 9 is a schematic diagram of another viewing-angle picture of a virtual wasp according to an embodiment of this application;

FIG. 10 is a schematic diagram of a viewing-angle picture of a second virtual object according to an embodiment of this application;

FIG. 11 is a schematic diagram of another viewing-angle picture of a second virtual object according to an embodiment of this application;

FIG. 12 is a flowchart of yet another method for controlling a virtual object according to an embodiment of this application;

FIG. 13 is a flowchart of still another method for controlling a virtual object according to an embodiment of this application;

FIG. 14 is a schematic structural diagram of an apparatus for controlling a virtual object according to an embodiment of this application;

FIG. 15 is a schematic structural diagram of another apparatus for controlling a virtual object according to an embodiment of this application;

FIG. 16 is a schematic structural diagram of an apparatus for controlling a virtual object according to an embodiment of this application; and

FIG. 17 is a schematic structural diagram of a terminal according to an embodiment of this application.

### DESCRIPTION OF EMBODIMENTS

To make the objectives, technical solutions, and advantages of embodiments of this application clearer, implementations of this application will be further described in detail below in combination with accompanying drawings.

Terms “first”, “second”, “third”, etc. used in this application may be used for describing various concepts herein, but these concepts are not limited by these terms unless otherwise specified. These terms are merely used for distinguishing one concept from another concept. For example, without departing from the scope of this application, a first virtual object may be referred to as a second virtual object. Similarly, a second virtual object may be referred to as a first virtual object.

In terms “at least one”, “a plurality of”, “each”, and “any one” used in this application, “at least one” includes one and two or more, “a plurality of” include two or more, “each” refers to each of a plurality of corresponding items, and “any one” refers to any one of a plurality of items. For example, a plurality of virtual objects include three virtual objects. “Each” refers to each of the three virtual objects. “Any one” refers to any one of the three virtual objects, and may refer to a first virtual object, or a second virtual object, or a third virtual object.

For ease of understanding of the embodiments of this application, nouns involved in the embodiments of this application will be first explained.

Virtual scene: a virtual scene displayed (or provided) when an application runs on a terminal, namely, a scene displayed when a terminal runs a game, and also referred to as a big world scene. The virtual scene is a simulated environment of the real world, or a semi-simulated and semi-fictive virtual environment, or a purely-fictive virtual environment. The virtual scene is any one of a two-dimensional virtual scene, a 2.5-dimensional virtual scene, and a three-dimensional virtual scene. This is not limited in this application. For example, the virtual scene includes a sky, land, an ocean, etc. The land includes a desert, a city, and other environment elements. A user can control a virtual object to move in the virtual scene. Certainly, the virtual scene further includes a virtual item, such as a thrown object, a building, and a vehicle. The virtual scene can be further used for simulating real environments in different kinds of weather, such as a sunny day, a rainy day, a foggy day, or a night. Various scene elements enhance diversity and realness of the virtual scene.

Virtual object: a virtual role movable in a virtual scene. The movable object is a virtual character, a virtual animal, or a cartoon character, etc. The virtual object is a virtual image for representing a user in the virtual scene. The virtual scene includes a plurality of virtual objects. Each virtual object has its own shape and size in the virtual scene and occupies some space of the virtual scene. In some embodiments, the virtual object is a role controlled through an operation on a client, or an artificial intelligence (AI) role set in a virtual environment through training, or a non-player character (NPC) set in a virtual scene. In some embodiments, the virtual object is a virtual character participating in competition in the virtual scene.

Virtual item: an item that can be used by the virtual object in the virtual scene. For example, the virtual item is a virtual bullet, a virtual dart pin, virtual venom, etc.

Data (including but not limited to game data for rendering a viewing-angle picture) and signals involved in this application are all authorized by a user or fully authorized by all parties. Related data are required to be collected, used, and processed in accordance to related laws and regulations and standards of related countries and regions. For example, all game data involved in this application are all authorized to be acquired.

A method for controlling a virtual object provided in embodiments of this application may be performed by a terminal. In some embodiments, the terminal may be a smartphone, a tablet computer, a notebook computer, a desktop computer, a smart speaker, a smartwatch, an intelligent voice interaction device, an intelligent appliance, or an on board terminal, etc., but is not limited thereto.

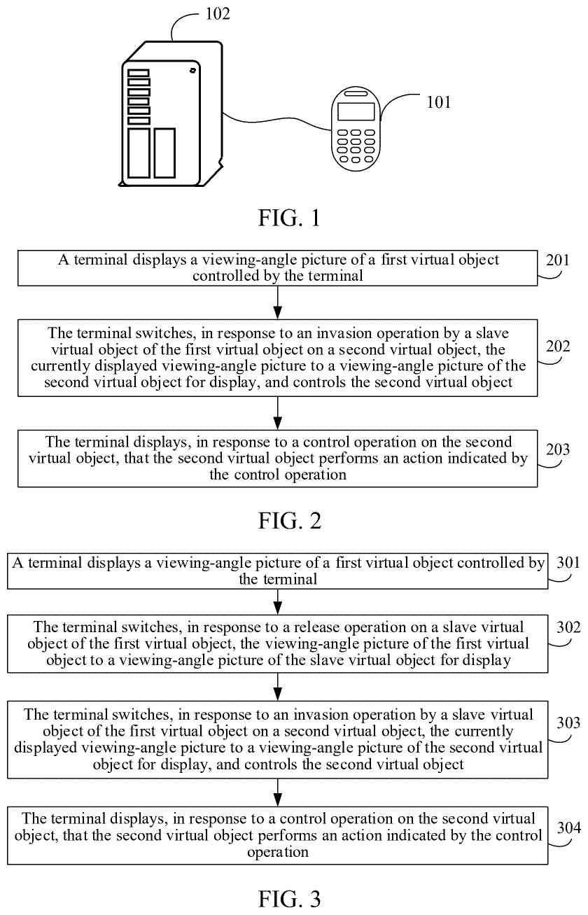

FIG. 1 is a schematic diagram of an implementation environment according to an embodiment of this application. With reference to FIG. 1, the implementation environment includes a terminal 101 and a server 102. The terminal 101 is connected to the server 102 by using a wireless or wired network.

An application serviced by the server 102 is mounted on the terminal 101. The application supports display of a viewing-angle picture of a virtual object. The terminal 101 can implement a game, message interaction, and other functions by using the application. In some embodiments, the application is an application in an operating system of the terminal 101, or an application provided by a third party. For example, the application is a game application, and the game application has a game function. Certainly, the game application can further have another function such as a shopping function, a navigation function, and a message interaction function. The terminal 101 is a terminal used by any user. The user can operate, by using the terminal 101, a virtual object in a virtual scene to perform an activity. The activity includes at least one of crawling, walking, running, jumping, driving, picking, shooting, attacking, and throwing. In some embodiments, different users control virtual objects by using different terminals respectively, and the virtual objects controlled by using the different terminals are located in the same virtual scene. In this case, the different virtual objects can perform activities.

In some embodiments, the server 102 is an independent physical server, or a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform.

In some embodiments, a computer program of the application is deployed on one server to be executed, or is executed on a plurality of servers located at one site, or is executed on a plurality of servers that are distributed at a plurality of sites and interconnected by using a communications network. The plurality of servers that are distributed at a plurality of sites and interconnected by using a communications network can form a block chain system.

The terminal 101 is configured to log in an application based on a user identity, and interact with the server 102 by using the application such that a viewing-angle picture of a first virtual object controlled by the terminal 101 can be displayed. Through a method of invading the second virtual object by a slave virtual object of the first virtual object, the currently displayed viewing-angle picture is switched to a viewing-angle picture of the second virtual object for display such that the terminal 101 can control the second virtual object. Thus, the second virtual object can be controlled.

FIG. 2 is a flowchart of a method for controlling a virtual object according to an embodiment of this application. The method is performed by a terminal. As shown in FIG. 2, the method includes:

201: The terminal displays a viewing-angle picture of a first virtual object controlled by the terminal.

In an embodiment of this application, the terminal can control the first virtual object to interact with another virtual object in a virtual scene. The viewing-angle picture of the first virtual object is a picture obtained by observing the virtual scene from a viewing angle of the first virtual object. The terminal displays the viewing-angle picture of the first virtual object. Thus, the user can observe the virtual scene from the viewing angle of the first virtual object, and control, according to the observed virtual scene, the first virtual object to interact with another virtual object.

The viewing angle of the first virtual object is a first-person viewing angle or a third-person viewing angle.

202: The terminal switches, in response to an invasion operation by a slave virtual object of the first virtual object on a second virtual object, the currently displayed viewing-angle picture to a viewing-angle picture of the second virtual object for display, and controls the second virtual object.

In an embodiment of this application, the first virtual object controlled by the terminal has the slave virtual object. The terminal can control the slave virtual object of the first virtual object. The slave virtual object has a function of invading another virtual object. In an embodiment of this application, invading another virtual object can be understood as occupying control authority over another virtual object. The user can control, by using the terminal, the slave virtual object to invade another virtual object such that the terminal can control the invaded virtual object. In addition, the terminal can control a virtual object to which a currently displayed viewing-angle picture belongs. Thus, when the terminal can control an invaded virtual object, a viewing-angle picture of the invaded virtual object is displayed. Thus, the user can observe a virtual scene from the viewing angle of the invaded virtual object, and control, according to the observed virtual scene, the invaded virtual object to interact with another virtual object in the virtual scene.

The slave virtual object can be represented as any image. For example, the slave virtual object is a virtual flying item, a virtual vehicle, or a bionic virtual object, etc. The invasion operation by the slave virtual object on the second virtual object may be triggered by the user by using the terminal, or may be automatically triggered when the slave virtual object satisfies a condition. The second virtual object may be any type of virtual object. For example, the second virtual object is an artificial intelligence virtual object in a virtual scene, or a virtual object controlled by the terminal of the user.

203: The terminal displays, in response to a control operation on the second virtual object, that the second virtual object performs an action indicated by the control operation.

In an embodiment of this application, when the terminal already displays a viewing-angle picture of the invaded second virtual object, the terminal already can control the second virtual object. In this case, the user can trigger the control operation by using the terminal to control the second virtual object to perform the action indicated by the control operation. Thus, a solution in which the user controls another virtual object by using the terminal can be implemented.

The control operation may be any type of operation. For example, the control operation is a movement operation or a shooting operation, etc. In a case that the control operation is the movement operation, the second virtual object moving in the virtual scene is displayed. In a case that the control operation is the shooting operation, the second virtual object shooting in the virtual scene is displayed.

In solutions provided in embodiments of this application, a slave virtual object of a virtual object has a function of invading another virtual object. By invading another virtual object by the slave virtual object, a terminal can control the invaded virtual object, and display a viewing-angle picture of the invaded virtual object. Thus, a user can observe a virtual scene from a viewing angle of the invaded virtual object, and control, according to the observed virtual scene, the invaded virtual object to interact with another virtual object in the virtual scene. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

Based on the embodiment shown in FIG. 2, in embodiments of this application, when the slave virtual object is released to invade the second virtual object, a viewing-angle picture of the slave virtual object may further be displayed. Thus, it is ensured that a displayed viewing-angle picture is kept synchronized with a currently controlled virtual object. A specific process can be obtained in detail with reference to the following embodiment.

FIG. 3 is a flowchart of a method for controlling a virtual object according to an embodiment of this application. The method is performed by a terminal. As shown in FIG. 3, the method includes:

301: The terminal displays a viewing-angle picture of a first virtual object controlled by the terminal.

In an embodiment of this application, the terminal can control one or more virtual objects. When the terminal displays a viewing-angle picture of a virtual object, the terminal currently controls the virtual object. In a case that the terminal displays the viewing-angle picture of the first virtual object, the terminal currently controls the first virtual object.

In a possible implementation, when displaying the viewing-angle picture of the first virtual object, the terminal further displays a first control option. The first control option is configured for controlling the first virtual object.

In an embodiment of this application, when displaying the viewing-angle picture of the first virtual object, the terminal can control the first virtual object. Thus, the terminal displays the first control option for controlling the first virtual object. The user can trigger the first control option by using the terminal to control the first virtual object.

The first control option is any type of control option. For example, the first control option is a movement option, a jump option, or a shooting option, etc. The movement option is configured for controlling the first virtual object to move in the virtual scene. The jump option is configured for controlling the first virtual object to jump in the virtual scene. The shooting option is configured for controlling the first virtual object to shoot by using a handheld virtual firearm.

In some embodiments, the terminal displays a plurality of different first control options. The different first control options are configured for controlling the first virtual object to perform different actions.

In some embodiments, the first control option displayed by the terminal includes a release option for the slave virtual object. The release option is configured for controlling the first virtual object to release the slave virtual object in the virtual scene. The release option is any type of option. For example, the release option is a button or another type of option.

302: The terminal switches, in response to a release operation on a slave virtual object of the first virtual object, the viewing-angle picture of the first virtual object to a viewing-angle picture of the slave virtual object for display.

In an embodiment of this application, when displaying the viewing-angle picture of the first virtual object, the terminal can trigger a release operation on the slave virtual object of the first virtual object such that the first virtual object can release the slave virtual object in the virtual scene. In a case that the slave virtual object is released, the viewing-angle picture of the first virtual object is switched to a viewing-angle picture of the slave virtual object for display such that the user can learn that the slave virtual object can be currently controlled by using the terminal. Thus, the user can observe the virtual scene from a viewing angle of the slave virtual object, and control, according to the observed virtual scene, the slave virtual object to interact with another virtual object in the virtual scene.

The viewing-angle picture of the slave virtual object is displayed from a first-person viewing angle of the slave virtual object, or is displayed from a third-person viewing angle of the slave virtual object. The release operation on the slave virtual object of the first virtual object is triggered by the user by using the terminal, or is automatically triggered when the slave virtual object satisfies a condition.

In a possible implementation, the release operation is automatically triggered every third duration. That is, when the terminal controls the first virtual object to play a game, the release operation is automatically triggered every third duration. Thus, the first virtual object can automatically release the slave virtual object in the virtual scene. The viewing-angle picture of the first virtual object is switched to the viewing-angle picture of the slave virtual object for display such that subsequently another virtual object can be invaded by the slave virtual object to be controlled. The third duration is any duration.

In a possible implementation, when displaying the viewing-angle picture of the first virtual object, the terminal further displays a release option for the slave virtual object. Operation 302 includes: switch, in response to a trigger operation on the release option, the viewing-angle picture of the first virtual object to the viewing-angle picture of the slave virtual object for display.

The release option is configured for releasing the slave virtual object of the first virtual object. In some embodiments, the release option is a skill option of the first virtual object. The first virtual object releasing the slave virtual object is equivalent to the first virtual object releasing a skill in the virtual scene to call the slave virtual object. The terminal detecting the trigger operation on the release option is equivalent to the terminal detecting the release operation on the slave virtual object of the first virtual object.

In some embodiments, the release option can be triggered only in an activated state. That is, in response to the trigger operation on the release option in the activated state, the viewing-angle picture of the first virtual object is switched to the viewing-angle picture of the slave virtual object for display.

In an embodiment of this application, the release option corresponds to cooling duration. The cooling duration indicates required waiting duration from time when the slave virtual object is released once to time when the slave virtual object can be released again. The cooling duration is minimum interval duration for releasing the slave virtual object. In a case that the release option is the skill option of the first virtual object, the cooling duration is equivalent to cooling duration of a skill of the first virtual object. After the release option is triggered, a state of the release option is switched from the activated state to a non-activated state. At this time, the release option cannot be triggered. When the duration in which the release option is in the non-activated state reaches the cooling duration, the release option is switched from the non-activated state to the activated state. At this time, the release option can be triggered.

In some embodiments, the terminal further displays an energy bar of the release option. The energy bar matches the cooling duration. When the release option is in the non-activated state, energy in the energy bar being gradually increased over time is displayed. In a case that the energy bar is full of energy, the release option is switched from the non-activated state to the activated state, and an activation effect of the release option is displayed. The activation effect indicates that the release option is in the activated state and can be triggered.

In a possible implementation, the slave virtual object can be released only when a state of the first virtual object satisfies a release condition of the slave virtual object. That is, operation 302 includes: switch, when the state of the first virtual object satisfies the release condition of the slave virtual object and in response to the release operation on the slave virtual object of the first virtual object, the viewing-angle picture of the first virtual object to the viewing-angle picture of the slave virtual object for display.

The release condition of the slave virtual object defines a state of the first virtual object when the slave virtual object is allowed to be released. In some embodiments, the release condition of the slave virtual object indicates that the slave virtual object cannot be released when the first virtual object is in a knocked-down state, a riding state, a swimming state, a reloading state, or a wingsuit state. In an embodiment of this application, the release condition defines states in which the virtual object cannot release the slave virtual object. In a case that the first virtual object is in a state other than these states, the first virtual object can release the slave virtual object.

In a possible implementation, a first control option is further displayed when the viewing-angle picture of the first virtual object is displayed. The first control option is configured for controlling the first virtual object. Thus, when a viewing-angle picture is switched for display, a displayed control option will also be switched. That is, the method further includes: switch, in response to the release operation on the slave virtual object, the first control option to a second control option for display. The second control option is configured for controlling the slave virtual object.

In an embodiment of this application, when displaying the viewing-angle picture of the first virtual object, the terminal can control the first virtual object. In this case, the first control option for controlling the first virtual object is displayed such that the user can trigger the first control option by using the terminal to control the first virtual object. In a case that the displayed viewing-angle picture is switched to the viewing-angle picture of the slave virtual object for display, the displayed first control option is switched to the second control option such that the user can be reminded that the terminal currently controls the slave virtual object. Thus, the user can control the slave virtual object by using the second control option displayed by the terminal. An operation by the user is facilitated, such that efficiency of human-computer interaction is improved.

The second control option is any type of control option. For example, the second control option is a movement option, an ascending option, a descending option, or an auxiliary option. The movement option is configured for controlling the slave virtual object to move in the virtual scene. The ascending option is configured for controlling the slave virtual object to ascend in the virtual scene. The descending option is configured for controlling the slave virtual object to descend in the virtual scene. The auxiliary option is configured for displaying another control option of the slave virtual object. In an embodiment of this application, the auxiliary option is equivalent to an entry of a plurality of control options, and can reduce control options displayed by the terminal to improve cleanliness of a displayed picture.

In some embodiments, the terminal displays a plurality of different second control options. The different second control options are configured for controlling the slave virtual object to perform different actions.

In a possible implementation, the method further includes: display, when the viewing-angle picture of the slave virtual object is displayed, the viewing-angle picture of the first virtual object in a form of a thumbnail.

In an embodiment of this application, when the viewing-angle picture of the slave virtual object is displayed, the viewing-angle picture of the first virtual object is displayed in a form of a thumbnail. Thus, the user not only can view the viewing-angle picture of the currently controlled slave virtual object, but also can learn situations around the first virtual object by viewing the thumbnail. Displayed content is enriched, such that a display effect is improved.

303: The terminal switches, in response to an invasion operation by the slave virtual object of the first virtual object on a second virtual object, the viewing-angle picture of the slave virtual object to a viewing-angle picture of the second virtual object for display, and controls the second virtual object.

In an embodiment of this application, when the terminal releases the slave virtual object of the first virtual object in the virtual scene, the terminal displays the viewing-angle picture of the slave virtual object to control the slave virtual object to invade the second virtual object. In a case of controlling the slave virtual object to invade the second virtual object, the terminal displays a viewing-angle picture of the invaded virtual object. Thus, the user can observe the virtual scene from a viewing angle of the invaded virtual object, and control, according to the observed virtual scene, the invaded virtual object to interact with another virtual object in the virtual scene.

For example, each of a plurality of users controls, by using an own terminal, a virtual object to interact with other virtual objects. For example, a first user controls a first virtual object by using a first terminal, a second user controls a second virtual object by using a second terminal, and the first terminal can control only the first virtual object but cannot control the second virtual object. However, when the slave virtual object of the first virtual object invades the second virtual object, the first terminal can control not only the first virtual object, but also the second virtual object. The first terminal currently displays the viewing-angle picture of the second virtual object such that the user can learn that the first terminal currently controls the second virtual object.

In an embodiment of this application, through a method of releasing the slave virtual object of the first virtual object, a picture is switched to the viewing-angle picture of the slave virtual object for display first. Thus, a user can control, by viewing the viewing-angle picture of the slave virtual object, the slave virtual object to search for another virtual object for invasion in a virtual scene. When the slave virtual object invades another virtual object, the terminal already can control the invaded virtual object, and display a viewing-angle picture of the invaded virtual object. Thus, it is ensured that the viewing-angle picture displayed by the terminal is the viewing-angle picture of the virtual object currently controlled by the terminal. The user can learn, by using the viewing-angle picture displayed by the terminal, which virtual object currently controlled by the terminal. Control by the user is facilitated, such that convenience of controlling the virtual object by the user is improved.

In a possible implementation, the invasion operation indicates that the slave virtual object is adsorbed on the second virtual object, or the invasion operation indicates that the slave virtual object enters the body of the second virtual object, or the invasion operation indicates that the slave virtual object enters a virtual garment worn by the second virtual object, or the invasion operation indicates that the slave virtual object transmits the virtual item to the second virtual object, etc.

The virtual garment is any type of garment. For example, the virtual garment is a virtual outfit worn by the second virtual object, such as a virtual bulletproof garment or a virtual armor, or is another type of garment. The virtual item may be any type of item. For example, the virtual item is a virtual liquid, a virtual bullet, or a virtual arrow, etc. The virtual liquid is any type of liquid. For example, the virtual liquid is a virtual toxin, or a virtual virus, etc. The invasion operation indicates the slave virtual object injecting the virtual liquid into the body of the second virtual object. The slave virtual object adsorbed on the second virtual object indicates the slave virtual object adsorbed on a surface of the body of the second virtual object. The various methods mentioned above can embody a process that the slave virtual object invades the second virtual object.

In an embodiment of this application, the invasion operation indicates how the slave virtual object invades the second virtual object. The slave virtual object is adsorbed on the second virtual object, or the slave virtual object enters the body of the second virtual object, or the slave virtual object enters the virtual garment worn by the second virtual object, or the slave virtual object transmits the virtual item to the second virtual object, which is equivalent to that the slave virtual object already invades the second virtual object. Invasion on the virtual object is implemented through any one of the various invasion methods. Diversity of games is improved, such that user experience is improved.

In a possible implementation, operation 303 includes: The terminal acquires, in response to the invasion operation by the slave virtual object of the first virtual object on the second virtual object, control authority over the second virtual object, and switches the viewing-angle picture of the slave virtual object to the viewing-angle picture of the second virtual object for display.

In an embodiment of this application, when acquiring the control authority over the second virtual object, the terminal can control the second virtual object.

In a possible implementation, the invasion operation by the slave virtual object on the second virtual object is triggered by the user. That is, operation 303 includes: switch, in response to the trigger operation on the displayed invasion option, the viewing-angle picture of the slave virtual object to the viewing-angle picture of the second virtual object for display, and cause the terminal to control the second virtual object.

The invasion option is configured for controlling the slave virtual object to invade another virtual object. The terminal detecting the trigger operation on the invasion option is equivalent to the terminal detecting the invasion operation by the slave virtual object on the second virtual object.

In a possible implementation, the invasion operation by the slave virtual object on the second virtual object is automatically triggered when the slave virtual object satisfies a condition. That is, operation 303 includes: switch, when a distance between the slave virtual object and the second virtual object is less than a threshold or when the slave virtual object collides with the second virtual object, the viewing-angle picture of the slave virtual object to the viewing-angle picture of the second virtual object for display, and cause the terminal to control the second virtual object.

In an embodiment of this application, once it is detected that the distance between the slave virtual object and the second virtual object is less than the threshold, the invasion operation by the slave virtual object on the second virtual object is detected; or once the slave virtual object collides with the second virtual object, the invasion operation by the slave virtual object on the second virtual object is detected. The threshold is any value.

In a possible implementation, when displaying the viewing-angle picture of the slave virtual object, the terminal further displays a second control option. The second control option is configured for controlling the slave virtual object. Thus, when a displayed viewing-angle picture is switched, a displayed control option will also be switched. That is, the method further includes: switch, in response to the invasion operation by the slave virtual object on the second virtual object, the second control option to a third control option for display. The third control option is configured for controlling the second virtual object.

In an embodiment of this application, when the terminal detects the invasion operation by the slave virtual object on the second virtual object, the slave virtual object invades the second virtual object. The viewing-angle picture of the slave virtual object is switched to the viewing-angle picture of the second virtual object for display such that the user can control the second virtual object by using the viewing-angle picture displayed by the terminal. The displayed second control option is synchronously switched to the third control option such that the user can control the second virtual object by using the third control option. An operation by the user is facilitated, such that convenience of a trigger operation by the user is ensured.

In a possible implementation, when displaying the viewing-angle picture of the second virtual object, the terminal further displays a controlled effect of the second virtual object. The controlled effect indicates that the second virtual object is currently invaded. The controlled effect may be any type of special effect. For example, the controlled effect is an electric shock effect.

In a possible implementation, the method further includes: display, when displaying the viewing-angle picture of the second virtual object, the viewing-angle picture of the first virtual object in a form of a thumbnail.

In an embodiment of this application, when the viewing-angle picture of the second virtual object is displayed, the viewing-angle picture of the first virtual object is displayed in a form of a thumbnail. Thus, the user not only can view the viewing-angle picture of the currently controlled second virtual object, but also can learn situations around the first virtual object by viewing the thumbnail. Displayed content is enriched, such that a display effect is improved.

In an embodiment of this application, an example in which a picture is switched to the viewing-angle picture of the slave virtual object for display first and then a picture is switched to the viewing-angle picture of the invaded second virtual object for display is taken for description. In another embodiment, operations 302 and 303 are not required to be performed, and another method is used. In response to the invasion operation by the slave virtual object of the first virtual object on the second virtual object, the currently displayed viewing-angle picture is switched to the viewing-angle picture of the second virtual object for display. For example, when the viewing-angle picture of the first virtual object is displayed, in response to the invasion operation by the slave virtual object of the first virtual object on the second virtual object, the viewing-angle picture of the first virtual object is switched to the viewing-angle picture of the second virtual object for display.

304: The terminal displays, in response to a control operation on the second virtual object, that the second virtual object performs an action indicated by the control operation.

In a possible implementation, when displaying the viewing-angle picture of the second virtual object, the terminal further displays a third control option for controlling the second virtual object. Operation 304 includes: display, in response to a trigger operation on the third control option, that the second virtual object performs an action indicated by the third control option. The third control option is configured for controlling the second virtual object to perform an action. The action indicated by the third control option is an action which the third control option controls the second virtual object to perform.

In an embodiment of this application, the terminal not only displays the viewing-angle picture of the second virtual object, but also displays the third control option for controlling the second virtual object such that the user can control the second virtual object by using the second control option displayed by the terminal. An operation by the user can be facilitated, such that convenience of controlling the second virtual object by the user is improved.

In a possible implementation, operation 304 includes: display, in response to a shooting operation by the second virtual object, the second virtual object shooting based on a handheld virtual firearm; or display, in response to a virtual outfit switching operation by the second virtual object, the second virtual object switching a virtual outfit; or display, in response to a throwing operation by the second virtual object, the second virtual object throwing a handheld virtual throwing item.

In solutions provided in embodiments of this application, a slave virtual object of a virtual object has a function of invading another virtual object. By invading another virtual object by the slave virtual object, a terminal can control the invaded virtual object, and display a viewing-angle picture of the invaded virtual object. Thus, a user can observe a virtual scene from a viewing angle of the invaded virtual object, and control, according to the observed virtual scene, the invaded virtual object to interact with another virtual object in the virtual scene. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

In an embodiment of this application, through a method of releasing the slave virtual object of the first virtual object, a picture is switched to the viewing-angle picture of the slave virtual object for display first. Thus, a user can control, by viewing the viewing-angle picture of the slave virtual object, the slave virtual object to search for another virtual object for invasion in a virtual scene. When the slave virtual object invades another virtual object, the terminal already can control the invaded virtual object, and display a viewing-angle picture of the invaded virtual object. Thus, it is ensured that the viewing-angle picture displayed by the terminal is the viewing-angle picture of the virtual object currently controlled by the terminal. The user can learn, by using the viewing-angle picture displayed by the terminal, which virtual object currently controlled by the terminal. Control by the user is facilitated, such that convenience of controlling the virtual object by the user is improved.

Based on the embodiment shown in FIG. 3, the process that the slave virtual object invades the second virtual object includes any one of the following four methods.

A first method includes: display, in response to the invasion operation of the slave virtual object invading the second virtual object, the slave virtual object adsorbed on the second virtual object, and switch the viewing-angle picture of the slave virtual object to the viewing-angle picture of the second virtual object for display.

In an embodiment of this application, the slave virtual object adsorbed on the second virtual object indicates the slave virtual object invading the second virtual object.

In some embodiments, if the slave virtual object is a movable virtual object, an absorption process includes: the slave virtual object can move in the virtual scene after being released; and the terminal displays, in response to the invasion operation, the slave virtual object moving close to the second virtual object to be adsorbed on the second virtual object.

In an embodiment of this application, the slave virtual object is a movable virtual object. After the slave virtual object is released, the user can control, by using the terminal, the slave virtual object to move, in the virtual scene, close to the second virtual object which the user wants to invade, and trigger the invasion operation to make the slave virtual object adsorbed on the close second virtual object to invade the second virtual object.

For example, the slave virtual object is a virtual object that can walk on the ground of the virtual scene, such as a virtual vehicle or a virtual animal; or the slave virtual object is a virtual object that can fly in the virtual scene, such as a virtual aircraft or a virtual flying animal.

A second method includes: display, in response to the invasion operation of the slave virtual object invading the second virtual object, the slave virtual object transmitting a virtual item to the second virtual object; and switch, when the virtual item is adsorbed on the second virtual object, the viewing-angle picture of the slave virtual object to the viewing-angle picture of the second virtual object for display.

The slave virtual object has a function of transmitting a virtual item. The virtual item transmitted by the slave virtual object is any type of virtual item. For example, the virtual item is a poison needle, virtual venom, or another type of virtual item having an absorption function. Processes that the slave virtual object transmits the virtual item to the second virtual object and that the virtual item is adsorbed on the second virtual object are equivalent to a process that the slave virtual object invades the second virtual object. The terminal can display, in response to the invasion operation, the slave virtual object transmitting the virtual item to the second virtual object, and display the virtual item flying toward the second virtual object to be adsorbed on the second virtual object, to present an invasion process. Thus, a display effect can be ensured.

In a possible implementation, the slave virtual object is a virtual item handheld by the first virtual object, or a virtual carrier which the first virtual object rides, or a virtual apparatus placed on the ground of the virtual scene. For example, the slave virtual object is a virtual firearm handheld by the first virtual object, and the virtual firearm may transmit a virtual item for invading another virtual object; or the slave virtual object is a virtual vehicle, and the virtual vehicle may transmit a virtual item for invading another virtual object; or the slave virtual object is a virtual apparatus placed on the ground of the virtual scene, and the virtual apparatus may transmit a virtual item for invading another virtual object.

A third method includes: display, in response to the invasion operation of the slave virtual object invading the second virtual object, the slave virtual object entering a body of the second virtual object, and switch the viewing-angle picture of the slave virtual object to the viewing-angle picture of the second virtual object for display.

In an embodiment of this application, the slave virtual object has a function of entering a body of another virtual object. The slave virtual object entering the body of another virtual object is equivalent to a process that the slave virtual object successfully invades another virtual object.

A fourth method includes: display, in response to the invasion operation of the slave virtual object invading the second virtual object, the slave virtual object transmitting a virtual item to the second virtual object; and switch, when the virtual item enters the body of the second virtual object, the viewing-angle picture of the slave virtual object to the viewing-angle picture of the second virtual object for display.

In an embodiment of this application, the virtual item transmitted by the slave virtual object has a function of entering a body of another virtual object. Processes that the slave virtual object transmits the virtual item to the second virtual object and that the virtual item enters the body of the second virtual object are equivalent to a process that the slave virtual object invades the second virtual object.

In an embodiment of this application, in the virtual scene, the slave virtual object or the virtual item transmitted by the slave virtual object is adsorbed on the second virtual object, or the slave virtual object or the virtual item transmitted by the slave virtual object enters the body of the second virtual object. That is, the slave virtual object invades the second virtual object. The viewing-angle picture of the second virtual object is displayed. Before the viewing-angle picture of the second virtual object is displayed, a process that the slave virtual object invades the second virtual object is displayed such that a picture of the invasion process can be presented. Thus, a display effect can be ensured.

The above four methods are described with an example in which the currently displayed viewing-angle picture is the viewing-angle picture of the slave virtual object. In response to the invasion operation, a picture of the slave virtual object invading the second virtual object is displayed. Then, the currently displayed viewing-angle picture of the slave virtual object is switched to the viewing-angle picture of the second virtual object for display.

The embodiment shown in FIG. 3 is described with an example in which the viewing-angle picture of the slave virtual object is switched to the viewing-angle picture of the second virtual object for display. In another embodiment, when the slave virtual object is displayed, the viewing-angle picture of the slave virtual object may be directly switched to the viewing-angle picture of the first virtual object such that the user can continue to control the first virtual object by using the terminal. That is, a process for switching to the viewing-angle picture of the first virtual object includes the following three methods.

A first method includes: switch, when a hit point of the slave virtual object becomes 0, the viewing-angle picture of the slave virtual object to the viewing-angle picture of the first virtual object for display.

In an embodiment of this application, if the hit point of the slave virtual object becomes 0, the slave virtual object cannot be continuously controlled to invade another virtual object. Thus, the viewing-angle picture of the slave virtual object is switched to the viewing-angle picture of the first virtual object for display, and it is reflected that the slave virtual object cannot be continuously controlled currently. Interaction methods are enriched, such that user experience is improved.

In a possible implementation, a process of reducing the hit point of the slave virtual object includes: reduce, in response to the slave virtual object being attacked, the hit point of the slave virtual object; or reduce the hit point of the slave virtual object as survival duration of the slave virtual object is increased.

In an embodiment of this application, when being released, the slave virtual object can be attacked by another virtual object. Once the slave virtual object is attacked, the hit point of the slave virtual object will be reduced. Or, when the slave virtual object is released, the hit point of the slave virtual object will be gradually reduced. The longer the survival duration of the slave virtual object is, the greater a reduced hit point of the slave virtual object is. A reduced hit point in unit duration of the slave virtual object is any value.

In an embodiment of this application, another virtual object may attack the slave virtual object to reduce the hit point of the slave virtual object such that the user can control a virtual object to attack the slave virtual object to avoid a risk of being invaded. Thus, interaction methods are enriched, interactivity between virtual objects is enhanced, and fun of a game is improved. Further, efficiency of human-computer interaction is improved, such that user experience is improved.

In an embodiment of this application, the hit point of the slave virtual object is reduced as the survival duration of the slave virtual object is increased. Thus, duration in which the slave virtual object can survive is limited such that an effect on balance of a game due to too long survival duration of the slave virtual object can be avoided. Fairness of the game can be ensured such that user experience can be ensured.

A second method includes: switch, when survival duration of the slave virtual object reaches first duration, the viewing-angle picture of the slave virtual object to the viewing-angle picture of the first virtual object for display.

In an embodiment of this application, duration in which the slave virtual object can exist after being released is the first duration. Once survival duration of the slave virtual object reaches the first duration, the slave virtual object will immediately disappear. The viewing-angle picture of the slave virtual object is not required to be displayed, and the viewing-angle picture of the first virtual object is returned. Thus, an effect on balance of a game due to too long survival duration of the slave virtual object can be avoided. Fairness of the game can be ensured such that user experience can be ensured.

The first duration is any duration. For example, the first duration is 60 seconds or 90 seconds.

In a possible implementation, the survival duration of the slave virtual object is duration in which the virtual object is released, or is duration in which the virtual object does not invade another virtual object after being released. In a case that the survival duration of the slave virtual object is the duration in which the virtual object is released, timing is started from time when the slave virtual object is released. No matter whether the slave virtual object invades another virtual object, once the survival duration of the slave virtual object reaches the first duration, the viewing-angle picture of the slave virtual object is switched to the viewing-angle picture of the first virtual object for display. In a case that the survival duration of the slave virtual object is duration in which the virtual object does not invade another virtual object after being released, timing is started from time when the slave virtual object is released. If the slave virtual object does not invade another virtual object but timing duration reaches the first duration, the viewing-angle picture of the slave virtual object is switched to the viewing-angle picture of the first virtual object for display.

A third method includes: switch, when the first virtual object is attacked, the viewing-angle picture of the slave virtual object to the viewing-angle picture of the first virtual object for display.

In an embodiment of this application, when the slave virtual object is released, the terminal displays the viewing-angle picture of the slave virtual object. Thus, once the first virtual object is attacked, the viewing-angle picture of the slave virtual object will be immediately switched to the viewing-angle picture of the first virtual object for display. Thus, the user can view, by using the terminal, the virtual scene from a viewing angle of the first virtual object, learn an attacking situation, and control the first virtual object to move or fight back to be prevented from being killed such that fun of the game can be ensured. A solution of interrupting a process that another virtual object releases a slave virtual object for invasion is implemented. Interaction methods are enriched, such that efficiency of human-computer interaction is improved.

In a possible implementation, in the above three methods, a control option is synchronously switched for display while a viewing-angle picture is switched for display. The method further includes: switch the displayed second control option to the first control option for display.

That is, the displayed second control option is switched to the first control option for display while the viewing-angle picture of the slave virtual object is switched to the viewing-angle picture of the first virtual object for display. The first control option is configured for controlling the first virtual object. The second control option is configured for controlling the slave virtual object.

In an embodiment of this application, when displaying the viewing-angle picture of the slave virtual object, the terminal further displays the second control option for controlling the slave virtual object. Thus, the terminal cannot continuously control the first virtual object in this case. Once the currently displayed viewing-angle picture is switched to the viewing-angle picture of the first virtual object for display, the first control option for controlling the first virtual object will be immediately displayed such that the user can control the first virtual object by using the displayed first control option. An operation by the user is facilitated, such that user experience is improved.

Based on the embodiment shown in FIG. 2, the second virtual object can be invaded only when the distance between the slave virtual object and the second virtual object satisfies an invasion condition. A specific process can be obtained in detail with reference to the following embodiment.

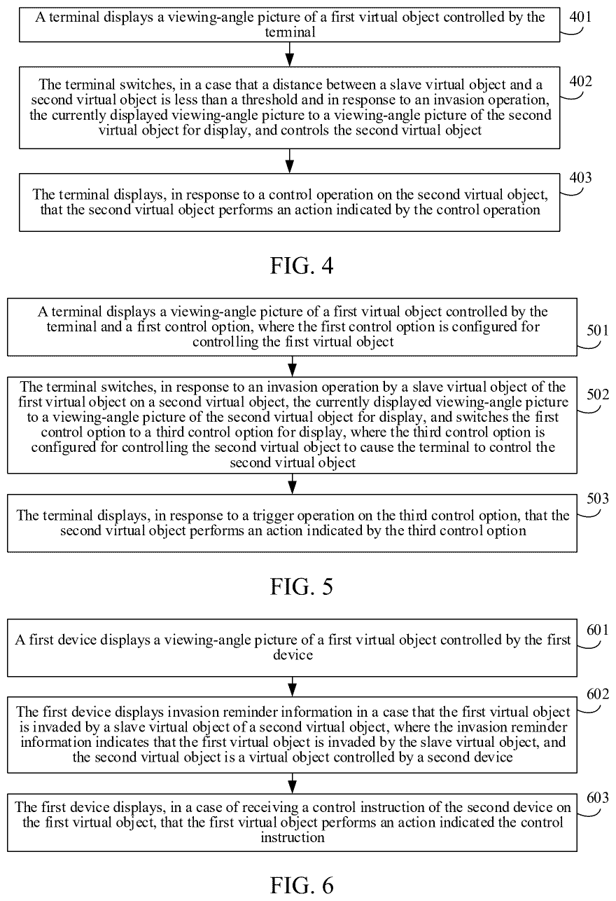

FIG. 4 is a flowchart of a method for controlling a virtual object according to an embodiment of this application. The method is performed by a terminal. As shown in FIG. 4, the method includes:

401: The terminal displays a viewing-angle picture of a first virtual object controlled by the terminal.

This operation is similar to operation 301 mentioned above, and will not be repeated herein.

402: The terminal switches, when a distance between a slave virtual object and a second virtual object is less than a threshold and in response to an invasion operation, the currently displayed viewing-angle picture to a viewing-angle picture of the second virtual object for display, and controls the second virtual object.

In an embodiment of this application, only when the distance between the slave virtual object and the second virtual object satisfies the invasion condition, the slave virtual object can invade the second virtual object. Thus, a difficulty of invading another virtual object by the slave virtual object can be ensured, a situation that fairness of the game is affected if the slave virtual object can excessively easily invade another virtual object can be avoided, and fun of the game can be ensured.

The threshold is any value. The invasion condition is a condition required to be satisfied when the slave virtual object invades a virtual object. In an embodiment of this application, the invasion condition indicates that a distance between the slave virtual object and a to-be-invaded virtual object is less than a threshold.

In a possible implementation, an invasion process includes: display, in response to the invasion operation, the slave virtual object adsorbed on the second virtual object, and switch the currently displayed viewing-angle picture to the viewing-angle picture of the second virtual object for display; or display, in response to the invasion operation, the slave virtual object transmitting a virtual item to the second virtual object; and switch, when the virtual item is adsorbed on the second virtual object, the currently displayed viewing-angle picture to the viewing-angle picture of the second virtual object for display; or display, in response to the invasion operation, the slave virtual object entering a body of the second virtual object, and switch the currently displayed viewing-angle picture to the viewing-angle picture of the second virtual object for display; or display, in response to the invasion operation, the slave virtual object transmitting a virtual item to the second virtual object; and switch, when the virtual item enters a body of the second virtual object, the currently displayed viewing-angle picture to the viewing-angle picture of the second virtual object for display.

In an embodiment of this application, the currently displayed viewing-angle picture is the viewing-angle picture of the first virtual object. According to the above invasion process, in response to the invasion operation, a picture of the slave virtual object invading the second virtual object is displayed, and the currently displayed viewing-angle picture of the first virtual object is switched to the viewing-angle picture of the second virtual object for display.

In an embodiment of this application, in the virtual scene, the slave virtual object or the virtual item transmitted by the slave virtual object is adsorbed on the second virtual object, or the slave virtual object or the virtual item transmitted by the slave virtual object enters the body of the second virtual object. That is, the slave virtual object invades the second virtual object. The viewing-angle picture of the second virtual object is displayed. Before the viewing-angle picture of the second virtual object is displayed, a process that the slave virtual object invades the second virtual object is displayed such that a picture of the invasion process can be presented. Thus, a display effect can be ensured.

In a possible implementation, operation 402 includes: switch, when the distance between the slave virtual object and the second virtual object is less than the threshold and the slave virtual object is aimed at the second virtual object and in response to the invasion operation, the currently displayed viewing-angle picture to the viewing-angle picture of the second virtual object for display.

In an embodiment of this application, only when the distance between the slave virtual object and the second virtual object is less than the threshold and the slave virtual object is aimed at the second virtual object, the slave virtual object can invade the second virtual object. Thus, mistaken invasion caused by distances between the slave virtual object and a plurality of virtual objects less than the threshold can be avoided such that accuracy of invasion can be ensured. An operation by a user can be simplified such that efficiency of human-computer interaction can be improved.

In some embodiments, when the slave virtual object is aimed at the second virtual object, the terminal further displays an aimed effect of the second virtual object. The aimed effect indicates that the slave virtual object is aimed at the second virtual object. The aimed effect can be represented in any form. For example, the aimed effect is displayed as a red object shape, or displayed in a form of an aiming aperture. The aiming aperture is an aperture in any shape.

In an embodiment of this application, the aimed effect is displayed such that the user can learn which virtual object is a target. Thus, the user can be reminded, such that a display effect is ensured.

In some embodiments, if the terminal displays an invasion option, operation 402 includes: switch, when the distance between the slave virtual object and the second virtual object is less than the threshold and the slave virtual object is aimed at the second virtual object and in response to a trigger operation on the invasion option, the currently displayed viewing-angle picture to the viewing-angle picture of the second virtual object for display.

In an embodiment of this application, detecting the trigger operation on the invasion option is equivalent to detecting the invasion operation by the slave virtual object on the second virtual object.

In some embodiments, an aiming process includes: display, in response to a scan operation by the slave virtual object, the slave virtual object scanning a virtual object in a scan range; and display, when the second virtual object is located in the scan range and the distance is less than the threshold, an aimed effect of the second virtual object, the aimed effect indicating that the slave virtual object is aimed at the second virtual object.

In an embodiment of this application, the slave virtual object corresponds to a scan range. Considering that a possibility that a virtual object outside the scan range satisfies an invasion condition is small, before invading any virtual object, the slave virtual object scans only a virtual object in the scan range to be aimed at the virtual object in the scan range without scanning excessive virtual objects. Thus, time consumption for scanning can be reduced such that aiming efficiency can be ensured. Moreover, it can be ensured that the slave virtual object can invade the target virtual object such that aiming accuracy can be ensured.

The scan range can be any range. In some embodiments, the scan range is a range of a region with the slave virtual object as a center. For example, the scan range is a range of a circular region or a square region with a position of the slave virtual object in the virtual scene as a center. In some embodiments, the scan range is a range of a viewing field of the slave virtual object or a partial range of a range of a viewing field of the slave virtual object. For example, when the scan range is the partial range of the range of the viewing field of the slave virtual object, the scan range is a range of a circular region or a square region with an intersection point of a line of sight of the slave virtual object and a display interface of the terminal as a center. For example, the display interface of the terminal is equivalent to a display screen of the terminal, and the terminal currently controls the viewing-angle picture of the slave virtual object. The display interface of the terminal displays the viewing-angle picture of the slave virtual object. The intersection point of the line of sight of the slave virtual object and the display interface of the terminal is located in a center of the display interface. A scan range of the slave virtual object is a range of a circular region or a square region with a center point of the display interface as a center.

In an embodiment of this application, the invasion conditions indicate that a distance between the slave virtual object and a to-be-invaded virtual object is less than a threshold, and the to-be-invaded virtual object is located in a scan range of the slave virtual object.

In some embodiments, the terminal displays a scan option. The terminal detecting the trigger operation on the scan option is equivalent to the terminal detecting the scan operation by the slave virtual object.

In some embodiments, an aiming process includes: display, in response to the scan operation by the slave virtual object, the slave virtual object scanning a plurality of virtual objects in a scan range; and display, when the slave virtual object scans the virtual objects in the scan range, a scanning frame traversing each virtual object in the scan range, determine a distance between each virtual object and the slave virtual object, and display the aimed effect of the second virtual object when each virtual object in the scan range is traversed and a plurality of virtual objects, each of which has a distance less than the threshold from the slave virtual object, exist in the scan range. The second virtual object is a virtual object, which has a smallest distance less than the threshold from the slave virtual object, of the plurality of virtual objects in the scan range.

In an embodiment of this application, a distance between each virtual object and the slave virtual object in the scan range is determined through scanning. A virtual object having a smallest distance from the slave virtual object is taken as a target virtual object such that accuracy of the target virtual object can be ensured. Moreover, a picture of the slave virtual object scanning each virtual object is presented, such that a display effect is improved.

The scanning frame is a scanning frame in any form. For example, the scanning frame is a circular scanning frame or square scanning frame.

In some embodiments, when the scanning frame traverses each virtual object in the scan range, the scanning frame is sequentially displayed on each virtual object. When the scanning frame is displayed on any virtual object, the virtual object is currently scanned. Thus, an effect of sequentially scanning each virtual object in the scan range can be presented.

In an embodiment of this application, only when the distance between the slave virtual object and the second virtual object is less than the threshold, the slave virtual object can invade the second virtual object. However, in another embodiment, operations 401 and 402 are not required to be performed, and another method is used. In response to the invasion operation by the slave virtual object of the first virtual object on the second virtual object, the currently displayed viewing-angle picture is switched to the viewing-angle picture of the second virtual object for display. For example, when the slave virtual object is aimed at the second virtual object and in response to the invasion operation by the slave virtual object of the first virtual object on the second virtual object, the currently displayed viewing-angle picture is switched to the viewing-angle picture of the second virtual object for display. Or, without satisfying any condition, only if the invasion operation by the slave virtual object of the first virtual object on the second virtual object is detected, the currently displayed viewing-angle picture is switched to the viewing-angle picture of the second virtual object for display.

403: The terminal displays, in response to a control operation on the second virtual object, that the second virtual object performs an action indicated by the control operation.

Operation 403 is similar to operation 304 mentioned above, and will not be repeated herein.

In solutions provided in embodiments of this application, a slave virtual object of a virtual object has a function of invading another virtual object. By invading another virtual object by the slave virtual object, a terminal can control the invaded virtual object, and display a viewing-angle picture of the invaded virtual object. Thus, a user can observe a virtual scene from a viewing angle of the invaded virtual object, and control, according to the observed virtual scene, the invaded virtual object to interact with another virtual object in the virtual scene. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

In an embodiment of this application, only when the distance between the slave virtual object and the second virtual object satisfies the invasion condition, the slave virtual object can invade the second virtual object. Thus, a difficulty of invading another virtual object by the slave virtual object can be ensured, a situation that fairness of the game is affected if the slave virtual object can excessively easily invade another virtual object can be avoided, and fun of the game can be ensured.

Based on the embodiment shown in FIG. 2, in an embodiment of this application, a displayed control option will be synchronously switched while the viewing-angle picture of the first virtual object is switched to the viewing-angle picture of the second virtual object. A specific process can be obtained in detail with reference to the following embodiment.

FIG. 5 is a flowchart of a method for controlling a virtual object according to an embodiment of this application. The method is performed by a terminal. As shown in FIG. 5, the method includes:

501: A terminal displays a viewing-angle picture of a first virtual object controlled by the terminal and a first control option, where the first control option is configured for controlling the first virtual object.

This operation is similar to operation 301 mentioned above, and will not be repeated herein.

502: The terminal switches, in response to an invasion operation by a slave virtual object of the first virtual object on a second virtual object, the currently displayed viewing-angle picture to a viewing-angle picture of the second virtual object for display, and switches the first control option to a third control option for display, where the third control option is configured for controlling the second virtual object to cause the terminal to control the second virtual object.

In an embodiment of this application, when displaying the viewing-angle picture of the first virtual object, the terminal can control the first virtual object. In this case, the first control option for controlling the first virtual object is displayed such that the user can trigger the first control option by using the terminal to control the first virtual object. In a case that the displayed viewing-angle picture is switched to the viewing-angle picture of the second virtual object for display, the displayed first control option is switched to the third control option such that the user can be reminded that the terminal currently controls the second virtual object. Thus, the user can control the second virtual object by using the third control option displayed by the terminal. An operation by the user is facilitated, such that efficiency of human-computer interaction is improved.

503: The terminal displays, in response to a trigger operation on the third control option, that the second virtual object performs an action indicated by the third control option.

In an embodiment of this application, the terminal not only displays the viewing-angle picture of the second virtual object, but also displays the third control option for controlling the second virtual object such that the user can control the second virtual object by using the second control option displayed by the terminal. An operation by the user can be facilitated, such that convenience of controlling the second virtual object by the user is improved.

In an embodiment of this application, an example in which the viewing-angle picture of the first virtual object is switched to the viewing-angle picture of the second virtual object is taken, and a displayed control option will also be synchronously switched. However, in another embodiment, operation 503 mentioned above is not required to be performed, and another method is used. In response to a control operation on the second virtual object, that the second virtual object performs an action indicated by the control operation is displayed.

In solutions provided in embodiments of this application, a slave virtual object of a virtual object has a function of invading another virtual object. By invading another virtual object by the slave virtual object, a terminal can control the invaded virtual object, and display a viewing-angle picture of the invaded virtual object. Thus, a user can observe a virtual scene from a viewing angle of the invaded virtual object, and control, according to the observed virtual scene, the invaded virtual object to interact with another virtual object in the virtual scene. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

Based on the above embodiments of FIG. 2 to FIG. 5, when the viewing-angle picture of the second virtual object is displayed, a picture may be directly switched to the viewing-angle picture of the first virtual object for display such that the user can continue to control the first virtual object by using the terminal. That is, a process for switching to the viewing-angle picture of the first virtual object for display includes the following five methods.

A first method includes: switch, when survival duration of the slave virtual object reaches first duration, the viewing-angle picture of the second virtual object to the viewing-angle picture of the first virtual object for display.

In an embodiment of this application, duration in which the slave virtual object can exist after being released is the first duration. Once survival duration of the slave virtual object reaches the first duration, the slave virtual object already cannot continuously control the second virtual object, and the viewing-angle picture of the first virtual object is returned. Thus, an effect on balance of a game due to too long survival duration of the slave virtual object can be avoided. Fairness of the game can be ensured such that user experience can be ensured.

The first method is similar to the above second method of switching the viewing-angle picture of the slave virtual object to the viewing-angle picture of the first virtual object for display, and will not be repeated herein.

A second method includes: switch, when duration in which the slave virtual object invades the second virtual object reaches second duration, the viewing-angle picture of the second virtual object to the viewing-angle picture of the first virtual object for display.

The second duration is any duration. Duration in which the slave virtual object invades the second virtual object is equivalent to duration in which the terminal controls the second virtual object.

In an embodiment of this application, any virtual object can be invaded only in the second duration. Once duration in which the slave virtual object invades the second virtual object reaches the second duration, the terminal cannot continuously control the second virtual object. The viewing-angle picture of the second virtual object is not required be displayed any more, and the viewing-angle picture of the first virtual object is returned. Thus, a situation that balance of a game is affected because the second virtual object is invaded for a long time can be avoided. Fairness of the game can be ensured such that user experience can be ensured.

In a possible implementation, a process for determining the second duration includes: determine the second duration based on at least one of a portion of the second virtual object which the slave virtual object invades, a type of the slave virtual object, and the hit point of the second virtual object.

In some embodiments, the second duration is determined based on the portion of the second virtual object which the slave virtual object invades. In an embodiment of this application, in cases of different portions of the second virtual object which the slave virtual object invades, the second duration in which the second virtual object can be invaded is different. For example, when a head of the second virtual object is invaded, the second duration is 60 seconds. In a case that a trunk of the second virtual object is invaded, the second duration is 50 seconds. In a case that a lower limb of the second virtual object is invaded, the second duration is 20 seconds. Different portions of the second virtual object correspond to different second duration. Various choices are provided for the user, such that diversity of games is enriched, and attraction to the user is improved.

In some embodiments, the second duration is determined based on the type of the slave virtual object. In an embodiment of this application, the virtual scene includes a plurality of types of slave virtual objects. Second duration corresponding to different types of slave virtual objects is different. For example, second duration corresponding to a slave virtual object belonging to a flying type is 60 seconds. Second duration corresponding to a slave virtual object belonging to a walking type is 50 seconds. For another example, second duration corresponding to a slave virtual object belonging to a bionic type is 80 seconds. Second duration corresponding to a slave virtual object belonging to an instrument type is 60 seconds. Since second duration corresponding to different types of slave virtual objects is different, various choices are provided for the user. Diversity of games is enriched, and attraction to the user is improved.

In some embodiments, the second duration is determined based on the hit point of the second virtual object. In an embodiment of this application, the hit point of the second virtual object is related to duration in which the second virtual object can be invaded. That is, the hit point of the second virtual object is related to the second duration. The greater the hit point of the second virtual object is, the longer the second duration is; and the less the hit point of the second virtual object is, the shorter the second duration is. Or, the greater the hit point of the second virtual object is, the shorter the second duration is; and the less the hit point of the second virtual object is, the longer the second duration is. Duration in which the second virtual object can be invaded is determined by using the hit point of the second virtual object. Thus, it can be ensured that the determined second duration matches the second virtual object, and accuracy of the determined second duration can be ensured. Moreover, diversity of games can be enriched, the user can select virtual objects having different hit points for invasion, such that efficiency of human-computer interaction is improved.

In some embodiments, the process that the second duration is determined based on the hit point of the second virtual object includes: determine a product of third duration and the hit point of the second virtual object as the second duration; or determine a product of the fourth duration and the hit point of the second virtual object, and determine a difference between fifth duration and the product as the second duration.

The third duration is duration, in which the virtual object can be invaded, corresponding to a unit hit point of the virtual object. By determining the product of the third duration and the hit point of the second virtual object as the second duration, the second duration is positively correlated with the hit point of the second virtual object have a positive correlation. Thus, it can be ensured that the determined second duration matches the second virtual object, and accuracy of the determined second duration can be ensured.

The fourth duration is reduced duration in which the virtual object can be invaded when per unit of hit point of the virtual object is reduced. The fifth duration is maximum duration in which each virtual object can be invaded. By determining the product of the fourth duration and the hit point of the second virtual object, and determining the difference between the fifth duration and the product as the second duration, the second duration is negatively correlated with the hit point of the second virtual object. Thus, it can be ensured that the determined second duration matches the second virtual object, and accuracy of the determined second duration can be ensured.

A third method includes: switch, when the first virtual object is attacked, the viewing-angle picture of the second virtual object to the viewing-angle picture of the first virtual object for display.

In an embodiment of this application, once the first virtual object is attacked, the viewing-angle picture of the second virtual object will be immediately switched to the viewing-angle picture of the first virtual object for display. Thus, the user can view, by using the terminal, the virtual scene from a viewing angle of the first virtual object, learn an attacking situation, and control the first virtual object to move or fight back to be prevented from being killed such that fun of the game can be ensured. A solution of interrupting invasion on another virtual object is implemented. Interaction methods are enriched, such that efficiency of human-computer interaction is improved.

A fourth method includes: switch, when a hit point of the second virtual object becomes 0, the viewing-angle picture of the second virtual object to the viewing-angle picture of the first virtual object for display.

In an embodiment of this application, if the hit point of the second virtual object becomes 0, the second virtual object cannot be continuously controlled. Thus, the viewing-angle picture of the second virtual object is switched to the viewing-angle picture of the first virtual object for display. It is reflected that the second virtual object cannot be continuously controlled currently. Interaction methods are enriched, and efficiency of human-computer interaction is improved, such that user experience is improved.

In a possible implementation, a process of reducing the hit point of the second virtual object includes: reduce, in response to the second virtual object being attacked, the hit point of the second virtual object; or reduce the hit point of the second virtual object as duration in which the second virtual object is invaded by the slave virtual object is increased.

In an embodiment of this application, once the second virtual object is attacked, the hit point of the second virtual object will be reduced. Or, when the second virtual object is invaded, the hit point of the second virtual object will be gradually reduced. The longer the duration in which the second virtual object is invaded is, the greater a reduced hit point of the second virtual object is. A reduced hit point per unit duration of the second virtual object is any value.

In an embodiment of this application, the hit point of the second virtual object is reduced as the duration in which the second virtual object is invaded by the slave virtual object is increased. Thus, a new attacking method is implemented. Through an invasion method, not only the second virtual object can be controlled, but also the hit point of the second virtual object can be reduced. Interaction methods are enriched such that users can be attracted to interaction through such a method. Interactivity between virtual objects can be enhanced, such that a fun of the game is improved. Further, efficiency of human-computer interaction is improved, such that user experience is improved.

A fifth method includes: switch, when a hit point of the slave virtual object becomes 0, the viewing-angle picture of the second virtual object to the viewing-angle picture of the first virtual object for display.

In an embodiment of this application, if the hit point of the slave virtual object becomes 0, the invaded virtual object cannot be continuously controlled by using the slave virtual object. Thus, the viewing-angle picture of the second virtual object is switched to the viewing-angle picture of the first virtual object for display. It is reflected that the second virtual object cannot be continuously controlled currently. Interaction methods are enriched, such that user experience is improved.

The fifth method is similar to the above first method of switching the viewing-angle picture of the slave virtual object to the viewing-angle picture of the first virtual object for display, and will not be repeated herein.

FIG. 6 is a flowchart of a method for controlling a virtual object according to an embodiment of this application. The method is performed by a first device. As shown in FIG. 6, the method includes:

601: The first device displays a viewing-angle picture of a first virtual object controlled by the first device.

The first device may be any type of device. For example, the first device is any type of terminal.

Operation 601 is similar to operation 201 mentioned above, and will not be repeated herein.

602: The first device displays invasion reminder information when the first virtual object is invaded by a slave virtual object of a second virtual object, the invasion reminder information indicating that the first virtual object is invaded by the slave virtual object, and the second virtual object being a virtual object controlled by a second device.

The invasion reminder information can be represented in any form. For example, the invasion reminder information is represented in a form of a special effect or represented in a form of text. The second device may be any type of device. For example, the second device is any type of terminal.

In an embodiment of this application, the first device can control the first virtual object. In a case that the first virtual object is invaded by the slave virtual object controlled by the second device, the first device cannot continuously control the first virtual object, but the second device can control the first virtual object.

603: The first device displays, when receiving a control instruction of the second device on the first virtual object, that the first virtual object performs an action indicated the control instruction.

In an embodiment of this application, the second device already can control the first virtual object in this case. The second device can trigger a control instruction on the first virtual object to control the first virtual object. However, the first device cannot continuously control the first virtual object, but can still continuously display a viewing-angle picture of the first virtual object, and display a picture showing the first virtual object controlled by the second device to perform an action.

In a possible implementation, the second device acquires, in response to an invasion operation by a slave virtual object of the second virtual object on the first virtual object, control authority over the first virtual object. After acquiring the control authority over the first virtual object, the second device displays, in response to the control operation on the first virtual object, that the first virtual object performs an action indicated by the control operation, and transmits a control instruction on the first virtual object to the first device. The control instruction is generated based on the control operation. An action indicated by the control instruction is the same as the action indicated by the control operation. For example, if the control operation is a jump operation, the control instruction is a jump instruction. The first device receives the control instruction, and displays that the first virtual object performs an action indicated by the control instruction.

In some embodiments, a target application serviced by a game server runs in the first device and the second device. The virtual object and the virtual scene involved in an embodiment of this application are game data provided in the target application. The game server provides background technical support for the target application. After acquiring the control authority over the first virtual object, the second device displays, in response to a control operation on the first virtual object, that the first virtual object performs an action indicated by the control operation, and transmits a control instruction on the first virtual object to the game server. The game server transmits the control instruction to the first device. The first device receives the control instruction, and displays that the first virtual object performs the action indicated by the control instruction.

In solutions provided in embodiments of this application, a slave virtual object of a virtual object has a function of invading another virtual object. By invading another virtual object by the slave virtual object, once a first virtual object controlled by a first device is invaded by a slave virtual object controlled by a second device, the first device cannot continuously control the first virtual object. The second device can control the first virtual object, and can trigger a control instruction on the first object. Moreover, the first device displays only a picture showing the first virtual object controlled by the second device to perform an action. Thus, a new method for controlling a virtual object is implemented. Not only a virtual object originally controlled by a device can be controlled, but also another virtual object can be controlled through an invasion method. Interaction methods in a virtual scene are enriched such that users can be attracted to interaction through an invasion method, and interactivity between virtual objects is enhanced. Further, efficiency of human-computer interaction is improved, such that user experience is improved.

Based on the embodiment shown in FIG. 6, when displaying the viewing-angle picture of the first virtual object, the first device further displays a control option. The control option is configured for controlling the first virtual object. The method further includes: switch, when the first virtual object is invaded by the slave virtual object, a state of the control option to a trigger-disabled state.

When the control option is in the trigger-disabled state, the control option cannot be triggered. That is, even if the user performs a trigger operation on the control option by using the terminal, the terminal will not respond based on the trigger operation. When in the trigger-disabled state, the control option can be represented in any form. For example, the control option in the trigger-disabled state is displayed in a form of a special effect. The control option may be displayed in a dark form, or a special effect in a cross form may be displayed on the control option.

In an embodiment of this application, when the first virtual object is invaded by the slave virtual object, the first terminal is equivalent to a fight watching terminal, and can display only the viewing-angle picture of the first virtual object and the control option in the trigger-disabled state, but cannot continuously control the first virtual object.

In an embodiment of this application, when the first virtual object is invaded by the slave virtual object, the state of the control option is switched to the trigger-disabled state to remind that the first virtual object is invaded. Thus, a powerful reminding effect is achieved, and displayed content is enriched, such that a display effect is improved. In addition, since the control option cannot be used in the trigger-disabled state, it is ensured that when the first virtual object is invaded by the slave virtual object, the first device cannot continuously control the first virtual object. That is, a control authority of the first device over the first virtual object is temporarily prohibited.

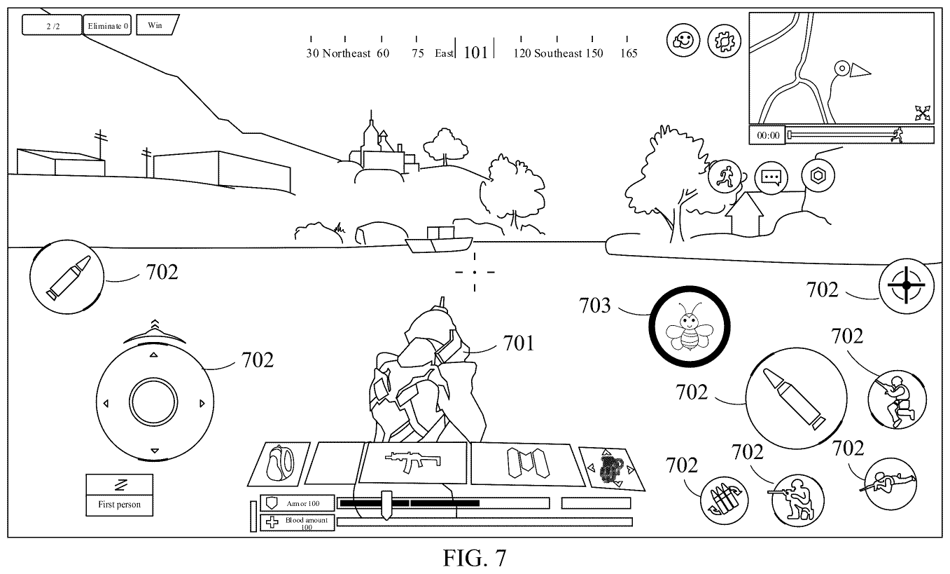

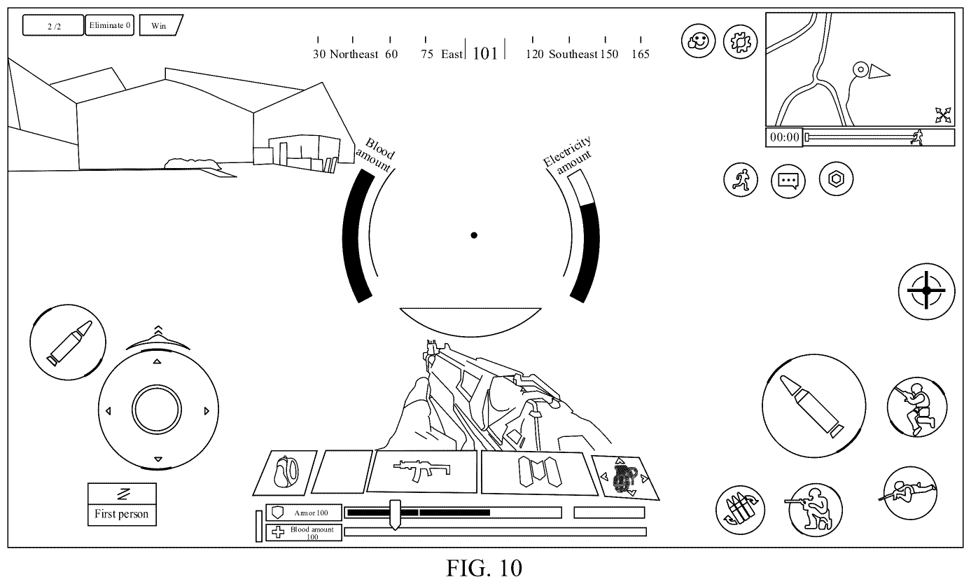

Based on the above embodiments shown in FIG. 2 to FIG. 6, in an embodiment of this application, for example, a first terminal controls a slave virtual object to invade a second virtual object controlled by a second terminal, and the slave virtual object is a virtual wasp. Viewing-angle pictures displayed by the first terminal are shown in FIG. 7 to FIG. 9. In a case that the second virtual object is invaded, a viewing-angle picture displayed by the second terminal is shown in FIG. 10.

FIG. 7 shows a picture displayed by a first terminal before invasion. The first terminal displays a viewing-angle picture of a first virtual object 701 and a plurality of first control options 702. The plurality of first control options include a movement option, an attack option, a jump option, a squat option, a lie-down option, a release option 703, etc. The release option 703 in FIG. 7 is in an activated state. Moreover, the first terminal further displays a thumbnail map of a virtual scene. The thumbnail map displays a display identity corresponding to the first virtual object and an orientation of the first virtual object. Moreover, the first terminal further displays a person switching option for switching between a first-person viewing angle and a third-person viewing angle to display a viewing-angle picture. FIG. 7 shows a first-person viewing-angle picture of the first virtual object 701 displayed by the first terminal.

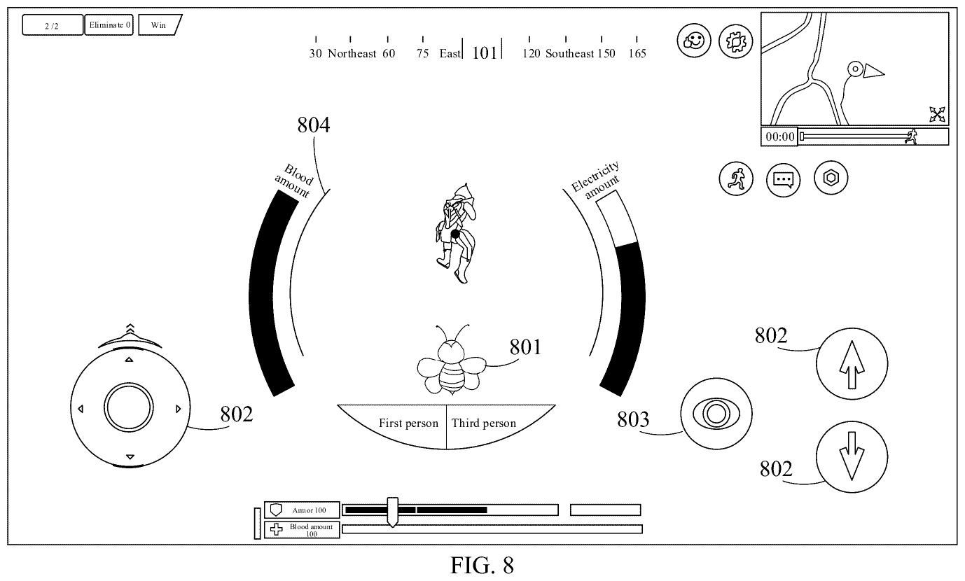

If a user clicks/taps the release option 703 by using the first terminal, the terminal will switch to a viewing-angle picture of the virtual wasp and the second control option for display, as shown in FIG. 8. In FIG. 8, the first terminal displays the viewing-angle picture of the virtual wasp 801 from a third-person viewing angle, and further displays a plurality of second control options 802. For example, the plurality of second control options include a movement option, an ascending option, a descending option, and an auxiliary option 803. The movement option is configured for controlling the virtual wasp to move. The ascending option is configured for controlling the virtual wasp to fly upwards. The descending option is configured for controlling the virtual wasp to fly downwards. The auxiliary option 803 is configured for displaying a scan option and an invasion option. Moreover, the first terminal further displays a blood amount and an electricity amount of the virtual wasp. The blood amount and the electricity amount are displayed in forms of energy bars. The blood amount represents a hit point of the virtual wasp. The electricity amount represents duration in which the virtual wasp can survive. The electricity amount is equivalent to a countdown of the survival duration of the virtual wasp. An electricity amount of 0 represents that the survival duration of the virtual wasp reaches maximum duration. The first terminal further displays a viewing angle switching option. The viewing angle switching option is configured for switching a person viewing angle of the viewing-angle picture of the virtual wasp. For example, the viewing angle switching option displayed by the first terminal includes a first-person option and a third-person option. In a case that the first-person option is selected, the terminal displays the viewing-angle picture of the virtual wasp from the first-person viewing angle. In a case that the third-person option is selected, the terminal displays the viewing-angle picture of the virtual wasp from the third-person viewing angle. Moreover, the first terminal may further display a scan range 804 of the virtual wasp.

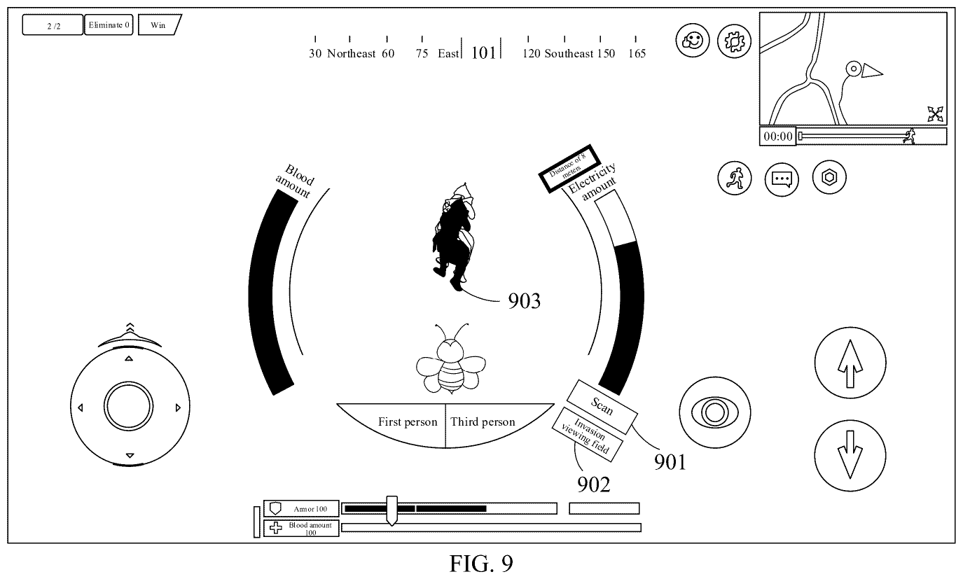

If the user clicks/taps the auxiliary option 803 by using the first terminal, the terminal will display a scan option and an invasion option, as shown in FIG. 9. In FIG. 9, the first terminal displays a scan option 901 and an invasion option 902. The scan option 901 is configured for triggering a scan operation. The invasion option 902 is configured for triggering an invasion operation. Moreover, the first terminal may further display a distance between the virtual wasp and the virtual object in the scan range, for example, “distance of 8 meters” in FIG. 9. In a case that the virtual wasp is aimed at the second virtual object, an aimed effect 903 of the second virtual object will be displayed.

Based on FIG. 9, the virtual wasp is aimed at the second virtual object. The user clicks/taps the invasion option 902 by using the first terminal. The terminal will switch to a viewing-angle picture of the second virtual object and a third control option for display, as shown in FIG. 10.

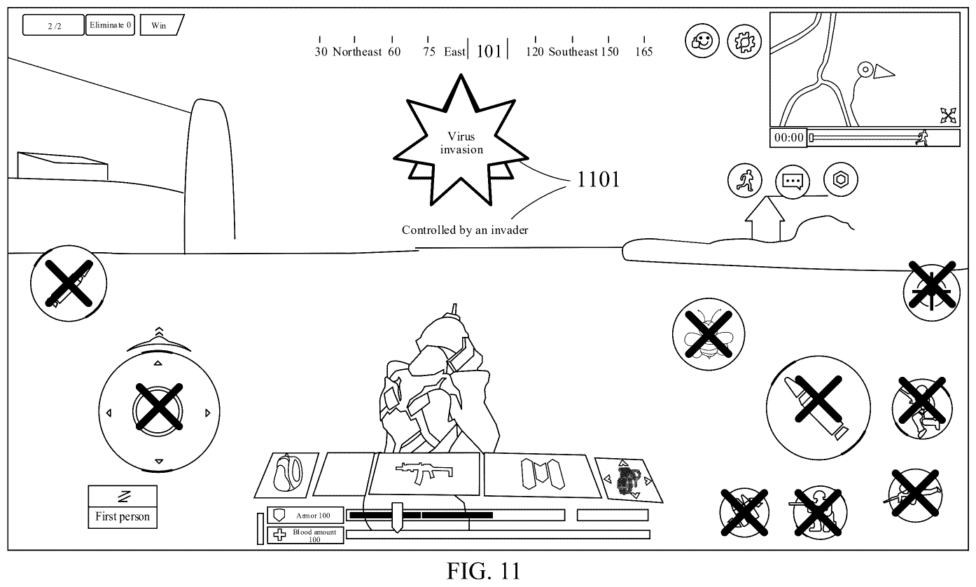

Moreover, when the second virtual object corresponding to the second terminal is invaded, a picture displayed by the second terminal is shown in FIG. 11. The second terminal displays invasion reminder information 1101, and displays a special effect in a form of a cross on each third control option to indicate that each third control option is in a trigger-disabled state.

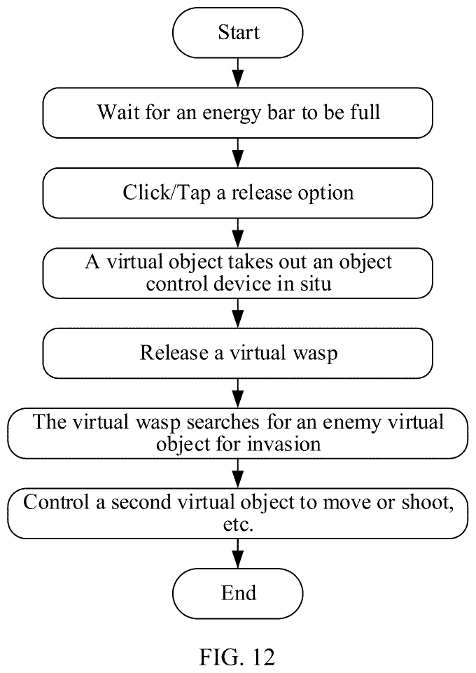

Based on the above embodiments shown in FIG. 2 to FIG. 11, an embodiment of this application further provides a flowchart of a method for controlling a virtual object. For example, a slave virtual object is released by using a release option, and the slave virtual object is a virtual wasp. As shown in FIG. 12, the method includes:

Operation 1: The first terminal displays an energy bar of a release option, and displays energy in the displayed energy bar being gradually increased over time. The first terminal displays, when the energy bar is full of energy and the release option is switched from a non-activated state to an activated state, an activation effect of the release option. At this time, the release option can be triggered.

Operation 2: The user clicks/taps the release option by using the first terminal. The first terminal displays the first virtual object taking out an object control device, the first virtual object keeping still, and the released virtual wasp above the first virtual object. The first terminal switches to the viewing-angle picture of the virtual wasp and the second control option for controlling the virtual wasp for display. The user can trigger, by using the first terminal, the second control option to control the virtual wasp to fly in the virtual scene.

The object control device is any virtual device in a virtual scene. The first terminal displays the first virtual object taking out the object control device in the virtual scene, and displays an action of the first virtual object controlling the object control device to release the virtual wasp. Thus, an effect that the first virtual object controls the virtual wasp by using the object control device can be simulated. A model of the object control device is mounted to a hand of the first virtual object such that a picture showing the first virtual object taking out the object control device can be displayed.

Operation 3: The user controls, by using the first terminal, the virtual wasp to fly to search for an enemy virtual object for invasion. In a case that the viewing-angle picture of the virtual wasp displays a virtual object belonging to an enemy camp, the user clicks/taps a scan option displayed by the first terminal, such that a slave virtual object scanning a virtual object in a scan range is displayed. The user determines a second virtual object as an invasion target, such that an aimed effect of the second virtual object is displayed.

The second virtual object is a virtual object at the enemy camp.

Operation 4: The user clicks/taps an invasion option displayed by the first terminal. The first terminal displays the virtual wasp injecting a virtual virus into the second virtual object, acquires control authority over the second virtual object, and displays a viewing-angle picture of the second virtual object and a third control option for controlling the second virtual object. The second terminal originally configured for controlling the second virtual object continuously displays the viewing-angle picture of the second virtual object and the third control option in a trigger-disabled state, and displays an electric shock effect indicating that the second virtual object is invaded.

Operation 5: The user controls, by triggering the third control option, the second virtual object to perform a corresponding action in the virtual scene.

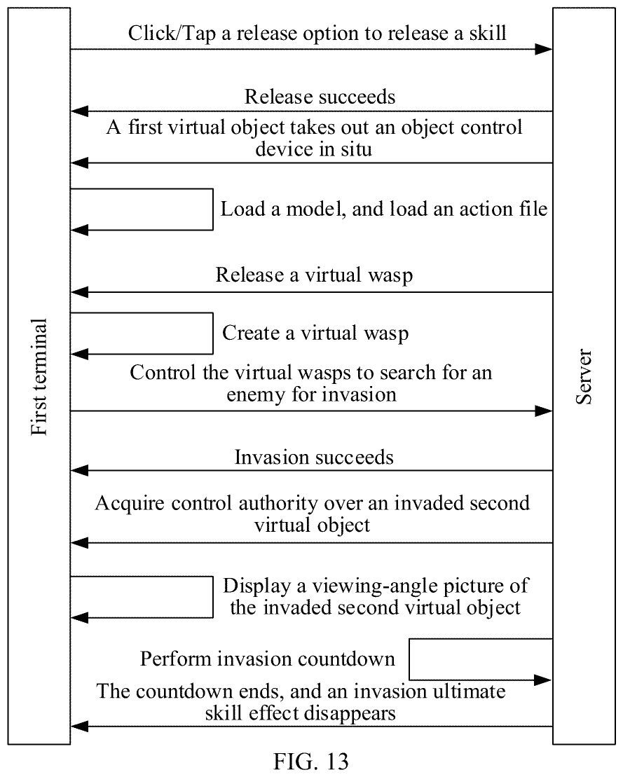

Based on the above embodiments shown in FIG. 2 to FIG. 12, an embodiment of this application further provides a flowchart of a method for controlling a virtual object. For example, a slave virtual object is released by using a release option, and the slave virtual object is a virtual wasp. As shown in FIG. 13, the method includes:

Operation 1: A first terminal detects a trigger operation on a release option, and transmits a network request packet to a server. The network request packet includes an account in which the first terminal logs, an object identity of a first virtual object, and an identity corresponding to the release option.

The account in which the first terminal logs is configured for representing a user and is equivalent to user information. The object identity of the first virtual object is equivalent to information about the virtual object. The identity corresponding to the release option indicates a skill corresponding to the release option.

Operation 2: The server receives the network request packet transmitted by the first terminal; searches, based on the object identity and the identity corresponding to the release option, for a state of the first virtual object and a skill corresponding to the release option; checks the account in which the first terminal logs, the state of the first virtual object, and the skill corresponding to the release option; and transmits, when a check result shows a success, a release success notification to the first terminal. The first terminal receives the success notification transmitted by the server.

By checking the account in which the first terminal logs, the state of the first virtual object, and the skill corresponding to the release option, whether the account in which the first terminal logs in the game and whether the state of the first virtual object satisfies a condition for releasing the skill can be determined. For example, whether the state of the first virtual object satisfies a release condition for releasing the virtual wasp is checked. The release success notification indicates that a check result shows a success, and the virtual wasp can be released.

Operation 3: The server transmits a first network packet to the first terminal. The first network packet includes the account in which the first terminal logs, the object identity of the first virtual object, and an identity of an object control device.

Operation 4: The first terminal receives the first network packet transmitted by the server; loads, when a check result about the account in which the first terminal logs and the object identity of the first virtual object included in the first network packet shows a success, based on the identity of the object control device, the object control device model and loads an action file; and plays an animation showing the first virtual object taking out the object control device to control the object control device.

Operation 5: The server transmits a second network package to each terminal participating in the game. The second network package includes the object identity of the first virtual object, an identity of the virtual wasp, location information of the virtual wasp, etc.

Thus, each terminal can create, based on the second network package, at a location indicated by the location information above the first virtual object, the virtual wasp indicated by the identity.

The object identity of the first virtual object is equivalent to information about a releaser.

Operation 6: The first terminal displays a viewing-angle picture of the virtual wasp and a second control option for controlling the virtual wasp.

Operation 7: The first terminal controls the virtual wasp to fly to search for a virtual object in an enemy camp for invasion; transmits, in response to a click/tap operation on the scan option, a scan network packet to the server; causes the server to check, based on the scan network packet, a location of the virtual object in a scan range and a location of the virtual wasp; determines a second virtual object which can be invaded by the virtual wasp; and transmits an object identity of the second virtual object to the first terminal. The first terminal displays an aimed effect of the second virtual object.

Operation 8: The first terminal transmits, in response to a click/tap operation on an invasion option, an invasion network packet to the server, and displays a picture showing the virtual wasp invading the second virtual object.

Operation 9: The server performs a location check and an object check based on the received invasion network packet; checks whether the to-be-invaded second virtual object can be invaded by the virtual wasp; transmits an invasion success notification to the first terminal after a check result shows yes; and transmits a third network packet for controlling an enemy party to the first terminal. The third network packet includes the object identity of the first virtual object, the object identity of the second virtual object, etc. Thus, the first terminal acquires control authority over the second virtual object.

Operation 10: The terminal receives the third network packet; displays, based on the third network packet, a viewing-angle picture of the second virtual object and a third control option; and causes a user to control, by triggering the third control option, the second virtual object to perform a corresponding action. A second terminal originally configured for controlling the second virtual object displays the viewing-angle picture of the second virtual object and a third control option in a trigger-disabled state.

Operation 11: The server sets invasion countdown; transmits an invasion end notification to the first terminal when the invasion countdown ends; and causes the terminal to return a viewing-angle picture of the first virtual object and a first control option for display and no longer control the second virtual object.

The method for controlling a virtual object provided in embodiments of this application can be applied to various scenes. For example, in a shooting game scene, the slave virtual object is a virtual wasp. In a case of displaying a viewing-angle picture of the first virtual object, the first terminal further displays a release option. Once the release option is triggered, the first terminal displays the first virtual object releasing the virtual wasp in the virtual scene, and the first terminal switches to the viewing-angle picture of the virtual wasp for display. By controlling the virtual wasp to release a virtual virus to invade the second virtual object, the first terminal acquires control authority over the second virtual object, and can display a viewing-angle picture of the second virtual object and a third control option. Thus, by triggering the third control option, the second virtual object can be controlled to perform a corresponding action. For example, the second virtual object is controlled to move, shoot, throw a grenade, etc. This application implements a method through which a player can control a virtual object of another player by using a terminal. This method makes a game funnier, stronger in operability, and higher in playability.

For example, a game application is mounted in a terminal. The method for controlling a virtual object is implemented by using the game application. When the terminal runs the game application, each node on which each game runs is recorded by using Root. When the terminal controls the virtual object to interact with another virtual object in a virtual scene, the virtual object can acquire a skill enhancement (buff) to enhance a state of the virtual object. The terminal can further render the viewing-angle picture by using a Renderer in the game application such that the terminal can display a picture of the virtual scene. Moreover, the game has a Prefab of a virtual object or a virtual item, and can load the Prefab to display a model of the virtual object or the virtual item. In addition, the terminal displays state information, such as a blood amount and an armor, of the virtual object by using a Heads-up Display (HUD).

Merely various exemplary methods are described above. In another embodiment, the above various exemplary methods may be combined in different manners to form other methods.

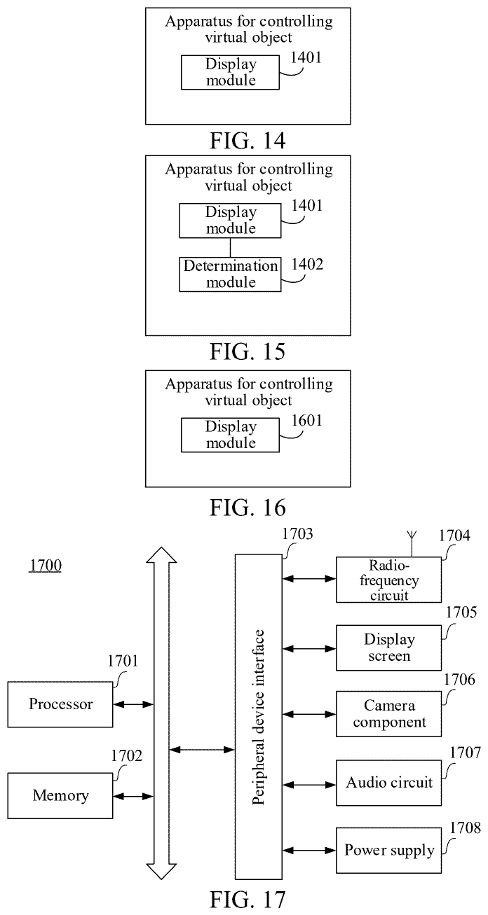

FIG. 14 is a schematic structural diagram of an apparatus for controlling a virtual object according to an embodiment of this application. As shown in FIG. 14, the apparatus includes:
a display module 1401 configured to display a viewing-angle picture of a first virtual object controlled by a terminal.

The display module 1401 is further configured to switch, in response to an invasion operation by a slave virtual object of the first virtual object on the second virtual object, the currently displayed viewing-angle picture to a viewing-angle picture of the second virtual object for display, and cause the terminal to control the second virtual object.

The display module 1401 is further configured to display, in response to a control operation on the second virtual object, that the second virtual object performs an action indicated by the control operation.

In a possible implementation, the display module 1401 is configured to display, in response to the invasion operation, the slave virtual object adsorbed on the second virtual object, and switch the currently displayed viewing-angle picture to the viewing-angle picture of the second virtual object for display; or display, in response to the invasion operation, the slave virtual object transmitting a virtual item to the second virtual object; and switch, when the virtual item is adsorbed on the second virtual object, the currently displayed viewing-angle picture to the viewing-angle picture of the second virtual object for display; or display, in response to the invasion operation, the slave virtual object entering a body of the second virtual object, and switch the currently displayed viewing-angle picture to the viewing-angle picture of the second virtual object for display; or display, in response to the invasion operation, the slave virtual object transmitting a virtual item to the second virtual object; and switch, when the virtual item enters a body of the second virtual object, the currently displayed viewing-angle picture to the viewing-angle picture of the second virtual object for display.

In another possible implementation, the display module 1401 is further configured to switch, in response to a release operation on the slave virtual object, the viewing-angle picture of the first virtual object to a viewing-angle picture of the slave virtual object for display.

The display module 1401 is further configured to switch, in response to the invasion operation, the viewing-angle picture of the slave virtual object to the viewing-angle picture of the second virtual object for display.

In yet another possible implementation, a first control option is further displayed when the viewing-angle picture of the first virtual object is displayed. The first control option is configured for controlling the first virtual object. The display module 1401 is further configured to switch, in response to the release operation on the slave virtual object, the first control option to a second control option for display. The second control option is configured for controlling the slave virtual object.

In yet another possible implementation, the display module 1401 is further configured to switch, when a hit point of the slave virtual object becomes 0, the viewing-angle picture of the slave virtual object to the viewing-angle picture of the first virtual object for display; or switch, when survival duration of the slave virtual object reaches first duration, the viewing-angle picture of the slave virtual object to the viewing-angle picture of the first virtual object for display; or switch, when the first virtual object is attacked, the viewing-angle picture of the slave virtual object to the viewing-angle picture of the first virtual object for display.

In yet another possible implementation, the display module 1401 is configured to switch, when a distance between the slave virtual object and the second virtual object is less than a threshold and in response to the invasion operation, the currently displayed viewing-angle picture to the viewing-angle picture of the second virtual object for display.

In yet another possible implementation, the display module 1401 is configured to switch, when the distance is less than the threshold and the slave virtual object is aimed at the second virtual object and in response to the invasion operation, the currently displayed viewing-angle picture to the viewing-angle picture of the second virtual object for display.

In yet another possible implementation, the display module 1401 is further configured to display, in response to a scan operation by the slave virtual object, the slave virtual object scanning a virtual object in a scan range; and display, when the second virtual object is located in the scan range and the distance is less than the threshold, an aimed effect of the second virtual object, the aimed effect indicating that the slave virtual object is aimed at the second virtual object.

In yet another possible implementation, a first control option is further displayed when the viewing-angle picture of the first virtual object is displayed. The first control option is configured for controlling the first virtual object. The display module 1401 is further configured to switch, in response to the invasion operation, the first control option to a third control option for display. The third control option is configured for controlling the second virtual object.

The display module 1401 is further configured to display, in response to a trigger operation on the third control option, that the second virtual object performs an action indicated by the third control option.

In yet another possible implementation, the display module 1401 is further configured to switch, when survival duration of the slave virtual object reaches first duration, the viewing-angle picture of the second virtual object to the viewing-angle picture of the first virtual object for display; or switch, when duration in which the slave virtual object invades the second virtual object reaches second duration, the viewing-angle picture of the second virtual object to the viewing-angle picture of the first virtual object for display; or switch, when the first virtual object is attacked, the viewing-angle picture of the second virtual object to the viewing-angle picture of the first virtual object for display; or switch, when a hit point of the second virtual object becomes 0, the viewing-angle picture of the second virtual object to the viewing-angle picture of the first virtual object for display; or switch, when a hit point of the slave virtual object becomes 0, the viewing-angle picture of the second virtual object to the viewing-angle picture of the first virtual object for display.

In yet another possible implementation, as shown in FIG. 15, the apparatus further includes:

a determination module 1402 configured to determine the second duration based on at least one of a portion of the second virtual object which the slave virtual object invades, a type of the slave virtual object, and the hit point of the second virtual object.

In still another possible implementation, the invasion operation indicates that the slave virtual object is adsorbed on the second virtual object, or the invasion operation indicates that the slave virtual object enters the body of the second virtual object, or the invasion operation indicates that the slave virtual object enters a virtual garment worn by the second virtual object, or the invasion operation indicates that the slave virtual object transmits the virtual item to the second virtual object, etc.

The apparatus for controlling a virtual object provided in the above embodiments is illustrated only with an example of division of the above function modules. During practical application, the above functions may be allocated to be completed by different function modules according to requirements. That is, the internal structure of the terminal is divided into different function modules to complete all or some of the functions described above. In addition, the above embodiments of an apparatus for controlling a virtual object belong to the same conception as the embodiments of a method for controlling a virtual object. An implementation process of the apparatus can be obtained with reference to the method embodiments, and will not be repeated herein.

FIG. 16 is a schematic structural diagram of an apparatus for controlling a virtual object according to an embodiment of this application. As shown in FIG. 16, the apparatus is configured in a first device and includes:
a display module 1601 configured to display a viewing-angle picture of a first virtual object controlled by the first device.

The display module 1601 is further configured to display invasion reminder information when the first virtual object is invaded by a slave virtual object of a second virtual object. The invasion reminder information indicates that the first virtual object is invaded by the slave virtual object. The second virtual object is a virtual object controlled by a second device.

The display module 1601 is further configured to display, when receiving a control instruction of the second device on the first virtual object, that the first virtual object performs an action indicated the control instruction.

In a possible implementation, a control option is further displayed when the viewing-angle picture of the first virtual object is displayed. The control option is configured for controlling the first virtual object. The display module 1601 is further configured to switch, when the first virtual object is invaded by the slave virtual object, a state of the control option to a trigger-disabled state.

The apparatus for controlling a virtual object provided in the above embodiments is illustrated only with an example of division of the above function modules. During practical application, the above functions may be allocated to be completed by different function modules according to requirements. That is, the internal structure of the terminal is divided into different function modules to complete all or some of the functions described above. In addition, the above embodiments of an apparatus for controlling a virtual object belong to the same conception as the embodiments of a method for controlling a virtual object. An implementation process of the apparatus can be obtained with reference to the method embodiments, and will not be repeated herein.

An embodiment of this application further provides a computer device. The computer device includes a processor and a memory. The memory has at least one computer program stored therein. The at least one computer program is loaded and executed by the processor to implement operations performed by the method for controlling a virtual object in the above embodiments.

In some embodiments, the computer device is provided as a terminal. FIG. 17 shows a structural block diagram of a terminal 1700 according to an exemplary embodiment of this application. The terminal 1700 includes: a processor 1701 and a memory 1702.

The processor 1701 may include one or more processing cores, such as a 4-core processor and an 8-core processor. The processor 1701 may be implemented in at least one hardware form of a digital signal processor (DSP), a field-programmable gate array (FPGA), and a programmable logic array (PLA).

The memory 1702 may include one or more computer-readable storage media. The computer-readable storage medium may be non-transient. The memory 1702 may further include a high speed random access memory and a non-volatile memory, such as one or more disk storage devices and flash storage devices. In some embodiments, the non-transitory computer-readable storage medium in the memory 1702 is configured for storing at least one computer program. The at least one computer program is configured for being executed by the processor 1701 to implement the method for controlling a virtual object provided in the method embodiments of this application.

In some embodiments, the terminal 1700 may further include: a peripheral device interface 1703 and at least one peripheral device. The processor 1701, the memory 1702, and the peripheral device interface 1703 may be connected by a bus or a signal line. Each peripheral device may be connected to peripheral device interface 1703 by a bus, a signal line, or a circuit board. Specifically, the peripheral device includes: at least one of a radio-frequency circuit 1704, a display screen 1705, a camera component 1706, an audio circuit 1707, and a power supply 1708.

A person skilled in the art can understand that the structure shown in FIG. 17 does not constitute a limitation on the terminal 1700. The terminal may include more or fewer components than those shown in the figure, or combine some components, or employ different component arrangements.

An embodiment of this application further provides a computer-readable storage medium. The computer-readable storage medium has at least one computer program stored therein. The at least one computer program is loaded and executed by the processor to implement operations performed by the method for controlling a virtual object in the above embodiments.

An embodiment of this application further provides a computer program product. The computer program product includes a computer program. When executed by a processor, the computer program implements operations performed by the method for controlling a virtual object in the above examples.

A person of ordinary skill in the art can understand that all or some of the operations implementing the above embodiments may be implemented by hardware, or may be implemented by instructing related hardware through a program. The program may be stored in a computer-readable storage medium. The above storage medium may be a read-only memory, a disk, an optical disc, etc.

Merely exemplary embodiments of embodiments of this application are described above, and not used to limit the embodiments of this application. Any modifications, equivalent substitutions, improvements, etc. made within the spirit and principle of embodiments of this application are to fall within the scope of protection of this application.

What is claimed is:

1. A method for controlling a virtual object performed by a computer device, comprising:
displaying a first virtual object's viewing-angle picture of a virtual scene controlled by the computer device;
in response to an invasion operation by a slave virtual object of the first virtual object on a second virtual object in the virtual scene, switching the currently displayed viewing-angle picture to the second virtual object's viewing-angle picture of the virtual scene; and
in response to a control operation on the second virtual object, causing the second virtual object to perform an action indicated by the control operation in the virtual scene.

2. The method according to claim 1, wherein the switching the currently displayed viewing-angle picture to the second virtual object's viewing-angle picture of the virtual scene comprises:
in response to the invasion operation, causing the slave virtual object to be adsorbed on the second virtual object, and switching the currently displayed viewing-angle picture to the viewing-angle picture of the second virtual object for display;
in response to the invasion operation, causing the slave virtual object to transmit a virtual item to the second virtual object and when the virtual item is adsorbed on the second virtual object, switching the currently displayed viewing-angle picture to the viewing-angle picture of the second virtual object for display;
in response to the invasion operation, causing the slave virtual object to enter a body of the second virtual object, and switching the currently displayed viewing-angle picture to the viewing-angle picture of the second virtual object for display; and
in response to the invasion operation, causing the slave virtual object to transmit a virtual item to the second virtual object and when the virtual item enters a body of the second virtual object, switching the currently displayed viewing-angle picture to the viewing-angle picture of the second virtual object for display.

3. The method according to claim 1, wherein the method further comprises:
before switching the currently displayed viewing-angle picture to the second virtual object's viewing-angle picture of the virtual scene:
switching, in response to a release operation on the slave virtual object, the viewing-angle picture of the first virtual object to the slave virtual object's viewing-angle picture of the virtual scene; and
switching, in response to the invasion operation, the slave virtual object's viewing-angle picture to the second virtual object's viewing-angle picture of the virtual scene for display.

4. The method according to claim 3, wherein a first control option is displayed when the viewing-angle picture of the first virtual object is displayed, and the first control option is configured for controlling the first virtual object; and the method further comprises:
switching, in response to the release operation on the slave virtual object, the first control option to a second control option configured for controlling the slave virtual object.

5. The method according to claim 3, wherein after switching, in response to the invasion operation, the slave virtual object's viewing-angle picture to the second virtual object's viewing-angle picture of the virtual scene for display, the method further comprises:
switching, when a hit point of the slave virtual object becomes 0, the viewing-angle picture of the slave virtual object to the viewing-angle picture of the first virtual object for display;
switching, when survival duration of the slave virtual object reaches first duration, the viewing-angle picture of the slave virtual object to the viewing-angle picture of the first virtual object for display; and
switching, when the first virtual object is attacked, the viewing-angle picture of the slave virtual object to the viewing-angle picture of the first virtual object for display.

6. The method according to claim 1, wherein the switching the currently displayed viewing-angle picture to the second virtual object's viewing-angle picture of the virtual scene comprises:
switching, when a distance between the slave virtual object and the second virtual object is less than a threshold, the currently displayed viewing-angle picture to the viewing-angle picture of the second virtual object for display.

7. The method according to claim 1, wherein a first control option is displayed when the viewing-angle picture of the first virtual object is displayed, and the first control option is configured for controlling the first virtual object; and the method further comprises:
switching, in response to the invasion operation, the first control option to a third control option for display, the third control option being configured for controlling the second virtual object; and
displaying, in response to a trigger operation on the third control option, that the second virtual object performs an action indicated by the third control option.

8. The method according to claim 1, wherein after switching the currently displayed viewing-angle picture to the second virtual object's viewing-angle picture of the virtual scene, the method further comprises:
switching, when the survival duration of the slave virtual object reaches the first duration, the viewing-angle picture of the second virtual object to the viewing-angle picture of the first virtual object for display;
switching, when duration in which the slave virtual object invades the second virtual object reaches second duration, the viewing-angle picture of the second virtual object to the viewing-angle picture of the first virtual object for display;
switching, when the first virtual object is attacked, the viewing-angle picture of the second virtual object to the viewing-angle picture of the first virtual object for display;
switching, when a hit point of the second virtual object becomes 0, the viewing-angle picture of the second virtual object to the viewing-angle picture of the first virtual object for display; and
switching, when the hit point of the slave virtual object becomes 0, the viewing-angle picture of the second virtual object to the viewing-angle picture of the first virtual object for display.

9. The method according to claim 1, wherein the invasion operation indicates that at least one of the slave virtual object being adsorbed on the second virtual object, the slave virtual object entering the body of the second virtual object, the slave virtual object entering a virtual garment worn by the second virtual object, and the slave virtual object transmitting the virtual item to the second virtual object.

10. A computer device, comprising a processor and a memory, the memory having at least one computer program stored therein, the at least one computer program being loaded and executed by the processor and causing the computer device to implement a method for controlling a virtual object including:
displaying a first virtual object's viewing-angle picture of a virtual scene controlled by the computer device;
in response to an invasion operation by a slave virtual object of the first virtual object on a second virtual object in the virtual scene, switching the currently displayed viewing-angle picture to the second virtual object's viewing-angle picture of the virtual scene; and
in response to a control operation on the second virtual object, causing the second virtual object to perform an action indicated by the control operation in the virtual scene.

11. The computer device according to claim 10, wherein the switching the currently displayed viewing-angle picture to the second virtual object's viewing-angle picture of the virtual scene comprises:
in response to the invasion operation, causing the slave virtual object to be adsorbed on the second virtual object, and switching the currently displayed viewing-angle picture to the viewing-angle picture of the second virtual object for display;
in response to the invasion operation, causing the slave virtual object to transmit a virtual item to the second virtual object and when the virtual item is adsorbed on the second virtual object, switching the currently displayed viewing-angle picture to the viewing-angle picture of the second virtual object for display;
in response to the invasion operation, causing the slave virtual object to enter a body of the second virtual object, and switching the currently displayed viewing-angle picture to the viewing-angle picture of the second virtual object for display; and
in response to the invasion operation, causing the slave virtual object to transmit a virtual item to the second virtual object and when the virtual item enters a body of the second virtual object, switching the currently displayed viewing-angle picture to the viewing-angle picture of the second virtual object for display.

12. The computer device according to claim 10, wherein the method further comprises:
before switching the currently displayed viewing-angle picture to the second virtual object's viewing-angle picture of the virtual scene:
switching, in response to a release operation on the slave virtual object, the viewing-angle picture of the first virtual object to the slave virtual object's viewing-angle picture of the virtual scene; and
switching, in response to the invasion operation, the slave virtual object's viewing-angle picture to the second virtual object's viewing-angle picture of the virtual scene for display.

13. The computer device according to claim 12, wherein a first control option is displayed when the viewing-angle picture of the first virtual object is displayed, and the first control option is configured for controlling the first virtual object; and the method further comprises:
switching, in response to the release operation on the slave virtual object, the first control option to a second control option configured for controlling the slave virtual object.

14. The computer device according to claim 12, wherein after switching, in response to the invasion operation, the slave virtual object's viewing-angle picture to the second virtual object's viewing-angle picture of the virtual scene for display, the method further comprises:
switching, when a hit point of the slave virtual object becomes 0, the viewing-angle picture of the slave virtual object to the viewing-angle picture of the first virtual object for display;
switching, when survival duration of the slave virtual object reaches first duration, the viewing-angle picture of the slave virtual object to the viewing-angle picture of the first virtual object for display; and
switching, when the first virtual object is attacked, the viewing-angle picture of the slave virtual object to the viewing-angle picture of the first virtual object for display.

15. The computer device according to claim 10, wherein the switching the currently displayed viewing-angle picture to the second virtual object's viewing-angle picture of the virtual scene comprises:
switching, when a distance between the slave virtual object and the second virtual object is less than a threshold, the currently displayed viewing-angle picture to the viewing-angle picture of the second virtual object for display.

16. The computer device according to claim 10, wherein a first control option is displayed when the viewing-angle picture of the first virtual object is displayed, and the first control option is configured for controlling the first virtual object; and the method further comprises:
switching, in response to the invasion operation, the first control option to a third control option for display, the third control option being configured for controlling the second virtual object; and
displaying, in response to a trigger operation on the third control option, that the second virtual object performs an action indicated by the third control option.

17. The computer device according to claim 10, wherein after switching the currently displayed viewing-angle picture to the second virtual object's viewing-angle picture of the virtual scene, the method further comprises:
switching, when the survival duration of the slave virtual object reaches the first duration, the viewing-angle picture of the second virtual object to the viewing-angle picture of the first virtual object for display;
switching, when duration in which the slave virtual object invades the second virtual object reaches second duration, the viewing-angle picture of the second virtual object to the viewing-angle picture of the first virtual object for display;
switching, when the first virtual object is attacked, the viewing-angle picture of the second virtual object to the viewing-angle picture of the first virtual object for display;
switching, when a hit point of the second virtual object becomes 0, the viewing-angle picture of the second virtual object to the viewing-angle picture of the first virtual object for display; and
switching, when the hit point of the slave virtual object becomes 0, the viewing-angle picture of the second virtual object to the viewing-angle picture of the first virtual object for display.

18. The computer device according to claim 10, wherein the invasion operation indicates that at least one of the slave virtual object being adsorbed on the second virtual object, the slave virtual object entering the body of the second virtual object, the slave virtual object entering a virtual garment worn by the second virtual object, and the slave virtual object transmitting the virtual item to the second virtual object.

19. A non-transitory computer-readable storage medium, having at least one computer program stored therein, the at least one computer program being loaded and executed by a processor of a computer device and causing the computer device to implement a method for controlling a virtual object including:
displaying a first virtual object's viewing-angle picture of a virtual scene controlled by the computer device;
in response to an invasion operation by a slave virtual object of the first virtual object on a second virtual object in the virtual scene, switching the currently displayed viewing-angle picture to the second virtual object's viewing-angle picture of the virtual scene; and
in response to a control operation on the second virtual object, causing the second virtual object to perform an action indicated by the control operation in the virtual scene.

20. The non-transitory computer-readable storage medium according to claim 19, wherein the switching the currently displayed viewing-angle picture to the second virtual object's viewing-angle picture of the virtual scene comprises:
in response to the invasion operation, causing the slave virtual object to be adsorbed on the second virtual object, and switching the currently displayed viewing-angle picture to the viewing-angle picture of the second virtual object for display;
in response to the invasion operation, causing the slave virtual object to transmit a virtual item to the second virtual object and when the virtual item is adsorbed on the second virtual object, switching the currently displayed viewing-angle picture to the viewing-angle picture of the second virtual object for display;
in response to the invasion operation, causing the slave virtual object to enter a body of the second virtual object, and switching the currently displayed viewing-angle picture to the viewing-angle picture of the second virtual object for display; and
in response to the invasion operation, causing the slave virtual object to transmit a virtual item to the second virtual object and when the virtual item enters a body of the second virtual object, switching the currently displayed viewing-angle picture to the viewing-angle picture of the second virtual object for display.
